(19) United States
(12) Patent Application Publication
(10) Pub. No.: US 2026/0245545 A1
(43) Pub. Date: Aug. 20, 2026

(54) INTERACTIVE IMMERSIVE EXPERIENCES USING MACHINE LEARNING

(71) Applicant: Lucasfilm Entertainment Company Ltd. LLC, San Francisco, CA (US)

(72) Inventors: Alexander Peck, Novato, CA (US); Michael Koperwas, San Francisco, CA (US)

(73) Assignee: Lucasfilm Entertainment Company Ltd. LLC, San Francisco, CA (US)

(21) Appl. No.: 19/056,665

(22) Filed: Feb. 18, 2025

(51) Int. Cl. G10L 13/10; G10L 13/027; G10L 15/183; G10L 15/22

(52) U.S. Cl. CPC G10L 13/10; G10L 13/027; G10L 15/183; G10L 15/22

(57) ABSTRACT

Methods and systems for improving interactive immersive experiences using machine learning are disclosed. In an interactive media experience, a user may speak to virtual characters displayed to the user (e.g., via a screen on a user device). The user's speech may be recorded to produce user speech data, which can be processed using a response model (e.g., a large language model) to generate a textual response and one or more tonal indicators. The one or more tonal indicators can be used to identify text-to-speech models that can be used to generate an audio response based on the textual response, which can then be played back to the user (e.g., via a speaker on the user device), thereby effectively communicating tonal information and achieving a more immersive user experience. Various other improvements to interactive media experiences are also disclosed, including methods for reducing communication latency and dealing with speech interruptions.

### BACKGROUND

Many forms of story-based entertainment media (e.g., books, movies, television, videogames, etc.) rely on scripted story content, e.g., stories that have been prepared in advanced by writers. Such stories are often fixed, unchanging, and have limited interactivity. For example, it is rare for a movie to have multiple endings, and while videogames may offer a player some influence over a story (e.g., by playing through the “hero story mode” or the “villain story mode”), usually such influence is limited, e.g., by letting the player select one of three options in a dialog tree. As a result, such media can often have limited “replay value”. This can be particularly noticeable in alternative entertainment forms, such as augmented reality (AR) or virtual reality (VR) media in which a user is “immersed” in the story itself, e.g., by taking on the role of a character in the AR or VR environment. While a reader can typically appreciate that the story in a book is unchanging and outside the reader's control, a user in an AR environment typically expects characters and the environment to react to the user in generally logic ways. When characters and the environment do not react to the user appropriately, it can be an “immersion breaking” experience and can negatively impact the user's enjoyment of the media.

Some forms of story-based entertainment are improvisational or reactive. Such entertainment usually relies on human entertainers or some form of media operator. For example, an improvisational comedy group can react to audience suggestions, and a “game master” in a tabletop roleplaying game can direct, change, or influence a roleplaying game story, or selectively enforce the rules of a roleplaying game to create a more immersive and enjoyable experience. However, such forms of entertainment are usually labor intensive, and have some difficulty scaling with the size of the audience or player base. An improvisational comedy group, for example, usually only interacts with a small subset of the audience, usually in a limited capacity (e.g., requesting a word or phrase to start a scene), and a game master can only handle a relatively small number of players before a roleplaying game becomes unmanageable.

Recent advances in generative artificial intelligence (AI) and machine learning (ML) have provided opportunities for new forms of interactive storytelling, usually involving stories generated using some form of large language model (LLM). Such machine learning models can generate coherent story content and can respond logically to user inputs. Further, they do not rely on human storytellers and can scale much more easily to large numbers of users via the use of distributed and/or large-scale computing systems.

However, the quality of stories produced by AI is still generally quite low, and they are almost never as compelling or interesting as stories produced by expert writers. Even sophisticated large language models rely on mathematical models of textual datasets, and do not have any true “understanding” of the semantic meaning of either their inputs or their outputs. While they can sometimes create a relatively convincing illusion of intelligence, machine learning models often struggle with the more nuanced aspects of human communication, including communicating based on long-term memory, evaluating tonal context, and responding to the dynamic and changing nature of conversation. Such issues are often noticeable in interactive immersive experiences (e.g., AR or VR experiences) and can be immersion breaking to players or other participants.

Embodiments address these and other problems, individually and collectively.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

Embodiments of the present disclosure are directed to various systems and methods for improving AI-based interactive media, including interactive immersive experiences such as AR or VR games or activities, or even communications between a user and an AI-based personal assistant. Some such systems and methods generally relate to improving communications or other interactions between users and virtual characters whose dialog or responses to users are generated using artificial intelligence and machine learning models (e.g., large language models). For example, if a player of a videogame is communicating with a virtual character whose dialog is generated via a large language model, methods and systems according to embodiments can be used to produce more natural and convincing dialog, e.g., dialog that conveys accurate tonal information, does not have unnatural pauses, etc.

Generally, a computer system according to embodiments (e.g., a server computer associated with an interactive media experience, e.g., a videogame server or a server associated with an AR game at a theme park) can receive user speech data from a user, e.g., via a user device (e.g., a smartphone that the user is using to play an AR game). The computer system can use a response model to generate a textual response to the user speech data and can additionally generate tonal indicators. The computer system can use the tonal indicators to select one or more text-to-speech models that can be used to produce an audio response. The computer system can input the textual response in the one or more text-to-speech models, thereby producing an audio response, which can be played back to the user e.g., by transmitting it to a user device, which can play the audio response back to the user via a speaker.

Each text-to-speech model can generally correspond to a different tone, which can further correspond to tonal indicators generated by the response model. For example, one text-to-speech model could correspond to an “excited” tone, while another text-to-speech model could correspond to a “whispering” tone. By enabling the response model to indicate the tone(s) associated with a response, and by generating different parts of the audio response via different text-to-speech models, the computer system can generate more natural and engaging audio responses to the user. This is in contrast with many previous methods of generating response audio via text-to-speech, in which a single text-to-speech model (usually corresponding to a particular character and not a given tone) would produce a monotone response, or would inadvertently produce a response with a given tone, e.g., due to the tone used by a voice actor when training the text-to-speech model.

Embodiments are directed to various other improvements to improving interactive media in which a computer system response to user speech data provided by a user. These can include systems and methods to reduce latency, which generally refers to the time it takes for a computer system to response to user after the user finishes providing their user speech data (e.g., after the user finishes speaking). In a typical conversation, a human listener will often response quite quickly to a speaker, even if just to indicate that they need more time to process what the speaker has said. Many machine learning models require large amounts of time to process responses to even short speeches by users, which can cause virtual characters to pause for unnatural amounts of time when speaking to a user in an interactive media experience. This can feel frustrating, unnatural, or “immersion-breaking” for users.

Generally, some embodiments address this problem by segmenting user speech data or audio responses and processing that user speech data and/or transmitting those audio responses sequentially. This enables a computer system according to embodiments to process and generate parts of a responses to a user before the user has finished speaking, greatly reducing the latency between when the user finishes speaking and when the user begins to hear the audio response. Further, such methods enable the computer system to process multiple elements or “segments” of user speech data concurrently, e.g., the computer system can generate an audio response based on a textual response while concurrently generating a textual response corresponding to a subsequent segment of user speech data, or e.g., the computer system can generate audio responses to the user device while the user is listening to previously generated audio responses.

Further, some embodiments are directed to methods and systems for addressing potential communication issues resulting from changing or conflicting aspects of user speech or interruptions in conversation. For example, a user may begin speaking about something at length, only to state something at the end of their speech which recontextualizes what the user had previously said. In this case, audio responses generated in response to early statements by the user may no longer be accurate. Likewise, a user may speak about something then pause to collect their thoughts without actually being finished speaking. In such cases, an interactive media experience system may begin to response to the user, only to be interrupted by the user as the user continues to speak.

Generally, embodiments of the present disclosure can address these problems by managing, modifying, or deleting contextual data provided to the response model, e.g., in view of more recent speech data received from a user. For example, such contextual data can include a history of user speech data and corresponding textual responses. If new speech data from the user recontextualizes their previous speech, such that some previously generated responses are incorrect or inappropriate, the computer system can remove these previous responses from the contextual information, thereby preventing those responses from leading to further inaccurate responses. Further, if the user begins speaking again during a response by the computer system, the computer system can stop sending audio responses to the user or could transmit a terminating signal to a user device, effectively muting playback of audio responses.

In more detail, one embodiment is directed to a method performed by a computer system for generating an audio response. The computer system can receive user speech data corresponding to a user. The computer system can use a response model to generate a textual response to the user speech data and one or more tonal indicators based on the user speech data. The computer system can determine one or more text-to-speech models corresponding to the one or more tonal indicators based on the one or more tonal indicators. The computer system can generate an audio response to the user speech data using the one or more text-to-speech models. The computer system can cause the audio response to be played to the user.

Another embodiment is directed to another method performed by a user device for generating an audio response and playing the audio response to a user. The user device can record the user, thereby generating a user audio recording. The user device can generate user speech data based on the user audio record. In some embodiments, the user speech data can comprise a transcription of the user audio recording. The user device can generate a textual response and one or more tonal indicators corresponding to the user speech data using a response model. The user device can determine one or more text-to-speech models corresponding to the one or more tonal indicators based on the one or more tonal indicators. The user device can generate the audio response to the user speech data using the one or more text-to-speech models. The user device can play the audio response to the user.

Another embodiment is directed to a computer system comprising one or more processors and a non-transitory computer readable medium coupled to the one or more processors. The non-transitory computer readable medium can comprise code, executable by the one or more processors to perform any of the methods described herein.

Embodiments of the present disclosure are described in more detail with reference to the Detailed Description below.

### Terms

A “server computer” may refer to a computer or cluster of computers. A server computer may be a powerful computing system, such as a large mainframe. Server computers can also include minicomputer clusters or a group of servers functioning as a unit. In one example, a server computer can include a database server coupled to a web server. A server computer may comprise one or more computational apparatuses and may use any of a variety of computing structures, arrangements, and compilations for servicing requests from one or more client computers.

A “client computer” may refer to a computer or cluster of computers that receives some service from a server computer (or another computing system). The client computer may access this service via a communication network such as the Internet or any other appropriate communication network. A client computer may make requests to server computers including requests for data. As an example, a client computer can request a video stream from a server computer associated with a movie streaming service. As another example, a client computer may request data from a database server. A client computer may comprise one or more computational apparatuses and may use a variety of computing structures, arrangements, and compilations for performing its functions, including requesting and receiving data or services from server computers.

A “memory” may refer to any suitable device or devices that may store electronic data. A suitable memory may comprise a non-transitory computer readable medium that stores instructions that can be executed by a processor to implement a desired method. Examples of memories including one or more memory chips, disk drives, etc. Such memories may operate using any suitable electrical, optical, and/or magnetic mode of operation.

A “processor” may refer to any suitable data computation device or devices. A processor may comprise one or more microprocessors working together to achieve a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or Xscale; and/or the like processor(s).

A “feature” can be an individual measurable property or characteristic of a phenomenon. One or more features can be described using a “feature vector,” e.g., a structured list of data (such as numerical data) representing those features. A feature can be input into a model to determine an output. As an example, in pattern recognition and machine learning, a feature vector can comprise an n-dimensional vector of numerical features that represent some object. In some machine learning contexts, a numerical representation of objects can facilitate processing and statistical analysis. In image processing for example, feature values might correspond to the pixels of an image. As another example, when feature vectors represent text, the features may comprise occurrence frequency of textual terms. Feature vectors can be equivalent to the vectors of explanatory variables used in statistical procedures such as linear regression.

A “data set” may include any set of one or more “observations” or “data values.” A “data value” can include any data element. A data value can comprise a “data vector,” which can comprise one or more values (represented in vector form) corresponding to a data element or observation.

A “data element” can refer to a set of data that can be grouped into a single unit, enabling comparison between that data element and other data elements. For example, a data element can comprise a single numerical value (e.g., the speed of a vehicle in miles per hour) or could comprise multiple numerical values (e.g., 60 speed recordings of a vehicle corresponding to each minute of an hour-long period). Data elements comprising multiple data values can be organized into various forms or structures, including data vectors and data tables. A data element may comprise the input to a machine learning model, and individual data values within that data element may comprise features.

The term “artificial intelligence model” or “machine learning model” can include a model that may be used to predict outcomes to achieve a pre-defined goal. A machine learning model may be developed using a learning process, in which training data is classified based on known or inferred patterns.

“Machine learning” can include an artificial intelligence process in which software applications may be trained to make accurate predictions through learning. The predictions can be generated by applying input data to a predictive model (or “prediction model”) formed from performing statistical analyses on aggregated data. A model can be trained using training data, such that the model may be used to make accurate predictions. As examples, predictions can include a classification of an image (e.g., identifying images of cats on the Internet) or recommendations (e.g., a movie that a user may like or a restaurant that a consumer might enjoy).

A “machine learning model” (ML model) can refer to a software module configured to be run on one or more processors to provide a classification or numerical value of a property of one or more samples. An ML model can include various parameters (e.g., for coefficients, weights, thresholds, functional properties of function, such as activation functions). As examples, an ML model can include at least 10, 100, 1,000, 5,000, 10,000, 50,000, 100,000, or one million parameters. An ML model can be generated using sample data (e.g., training samples) to make predictions on test data. Various number of training samples can be used, e.g., at least 10, 100, 1,000, 5,000, 10,000, 50,000, 100,000, or at least 200,000 training samples. One example is an unsupervised learning model such as a hidden Markov model (HMM), clustering (e.g., hierarchical clustering, k-means, mixture models, model-based clustering, density-based spatial clustering of applications with noise (DBSCAN), and OPTICS algorithm), approaches for learning latent variable models such as Expectation-maximization algorithm (EM), method of moments, and blind signal separation techniques (e.g., principal component analysis, independent component analysis, non-negative matrix factorization, singular value decomposition), and anomaly detection (e.g., local outlier factor and isolation forest). Another example type of model is a supervised learning model. Example supervised learning models may include different approaches and algorithms including analytical learning, statistical models, artificial neural network (e.g. including convolutional and/or transformer layers) that may have 1-10 layers as examples, recurrent neural network (e.g., long short term memory, LSTM), boosting (meta-algorithm), bootstrap aggregating (bagging) such as random forests, support vector machine (SVM), support vector (SVR), Bayesian statistics, case-based reasoning, decision tree learning, inductive logic programming, linear regression, logistic regression, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), ordinal classification, data pre-processing, handling imbalanced datasets, statistical relational learning, or Proaftn (a multicriteria classification algorithm), or an ensemble of any of these types. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

The process of “training” a machine learning model may include any steps used to prepare a machine learning model to perform some task. Often training involves determining or optimizing a set of “parameters” (which characterize the machine learning model) which result in acceptable model performance. Training can be performed in a series of “training rounds” during which training data is used to update the parameters of the machine learning model, for example, based on a loss value.

A “loss value” or “error value” may include any value that indicates the deviation between a result of some process, method, or function and an expected, desired, or correct result. For example, if a machine learning model can detect anomalies in a data set comprising 100 data values, 17 of which are anomalous, if the machine learning model only detects 15 of the 17 anomalous data values, the loss value could comprises, e.g., 2 (17-15). Loss values can be used to train and evaluate the training of machine learning models, e.g., by optimizing machine learning model parameters by minimizing the loss value, using processes such as stochastic gradient descent or backpropagation.

A “hyperparameter” can include any value used to configure a machine learning model that is external to the machine learning model. Typically, a hyperparameter is set, and is not estimated or determined from the training data that is used to train the machine learning model.

A machine learning model may comprise multiple “sub-models”, “layers,” or “modules”, which may refer to parts of a larger machine learning system. For example, a machine learning model could comprise a long short-term memory layer (which itself can comprise multiple layers), in addition to an attention layer and a linear layer. Layers can sometimes be organized in series, such that the input to a machine learning system is processed by a first set of layers, which produces an output that is then processed by a subsequent set of layers, and so forth until the output of the machine learning model is produced by the final layer in the series.

A “large language model” (LLM) generally refers to a machine learning or artificial intelligence model designed for natural language processing tasks, including interpreting language inputs (e.g. in the form of text) and generating text outputs. Large language models can be trained using self-supervised learning on large amounts of text, e.g., collected from the Internet. The input to a large language model, e.g., a generative text model, can be referred to as a “prompt”.

“Speech-to-text” or “speech recognition” refers to various (typically automated) methods to generate textual data from recorded audio (e.g., recorded audio speech data). A “speech-to-text model” can refer to a machine learning model (or other AI system, statistical model, etc.) that can be used to generate textual data from recorded audio. Similarly, “text-to-speech” refers to various (typically automated) methods to generate audio reminiscent of human speech, typically from text. A “speech-to-text model” can refer to a machine learning model (or other AI system, statistical model, etc.) that can be used to generate speech audio from textual data.

An “interactive media experience” can refer to any media experience in which a “user” or other participant interacts in some way with the media experience. A videogame in which a user controls a character (e.g., using a gamepad) in order to complete some objective is one example of an interactive media experience. Visual novels or “choose your own adventure” books are also examples of interactive media experiences, as a reader can make choices that influence the outcomes of stories. Communication with an AI virtual assistant (or other virtual character) is another example of an interactive media experience.

A “user” can refer to an individual that uses something for some purpose, e.g., a “user device”, which can refer to any device that is operated by a user. Examples of user devices include mobile phones, smart phones, cards, personal digital assistants (PDAs), laptop computers, desktop computers, server computers, vehicles such as automobiles, thin-client devices, tablet PCs, etc. Additionally, user devices can include any type of wearable technology device, such as watches, earpieces, glasses, etc. A user device may include one or more processors capable of processing user input. A user device may also include one or more input sensors for receiving user input. There are a variety of input sensors capable of detecting user input, such as accelerometers, cameras, microphones, etc. A user input obtained by input sensors may be from a variety of data input types, including, but not limited to, audio data, visual data, or biometric data. A user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

### BRIEF DESCRIPTION OF THE DRAWINGS

FIG. 1 shows a block diagram of an exemplary interactive media experience system according to some embodiments.

FIG. 2 shows a line drawing of a user point-of-view perspective for an interactive media experience involving a user device.

FIG. 3 shows a block diagram of an exemplary user device according to some embodiments.

FIG. 4 shows a flowchart of a method performed by a computer system for generating audio responses to user speech data according to some embodiments.

FIG. 5 shows a functional block diagram indicating some processes that can be performed by a computer system when performing some methods according to embodiments.

FIG. 6 shows a diagram of various data that can be used to generate a textual response using a response model.

FIG. 7 shows a block diagram of a text-to-speech model selection process according to some embodiments.

FIG. 8 shows a block diagram of various processes associated with playing audio response data and interrupting audio response playback.

FIG. 9 shows a flowchart of a method performed by a user device for generating audio responses to user speech data according to some embodiments.

FIG. 10 shows an exemplary computer system according to some embodiments.

### DETAILED DESCRIPTION

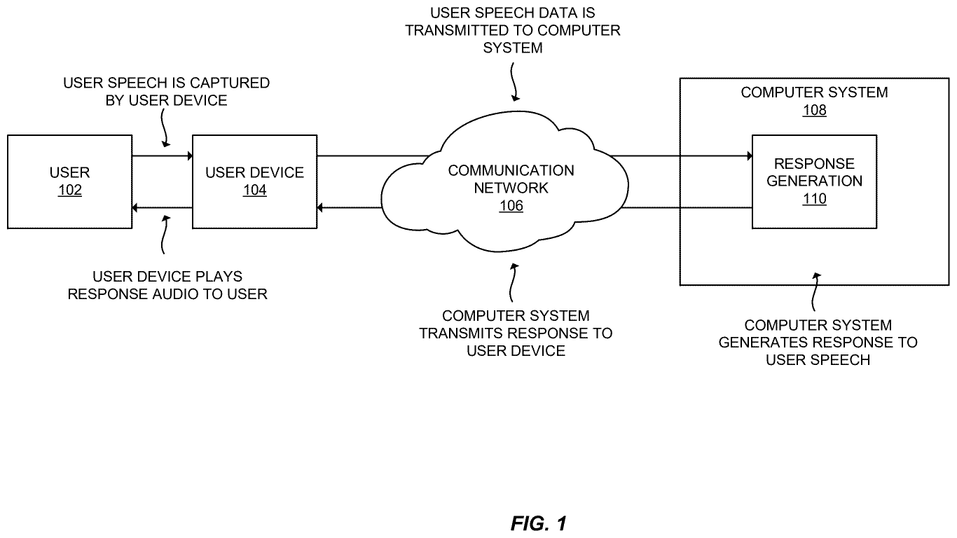

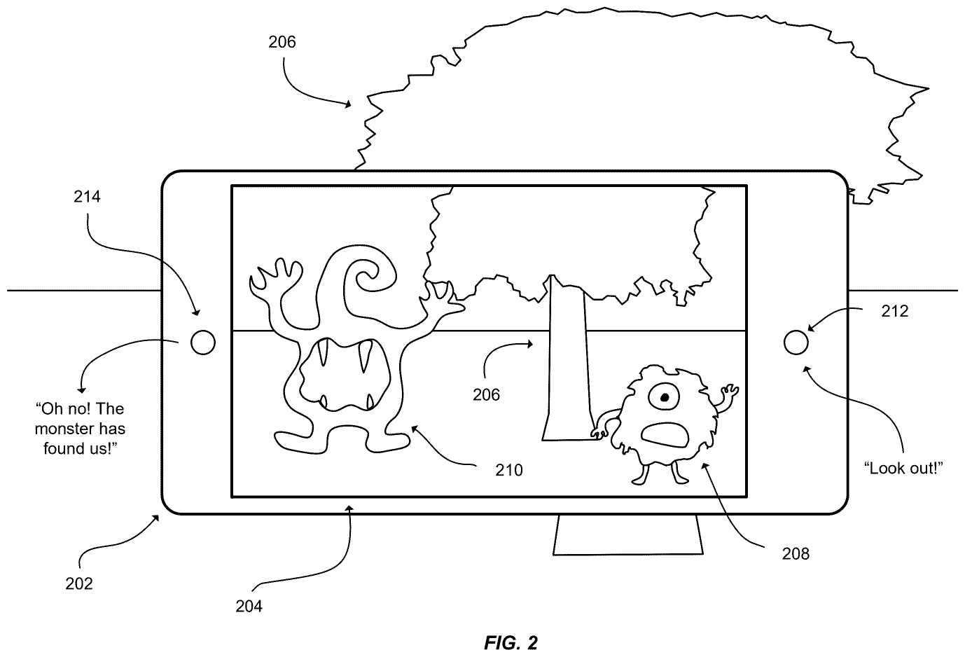

As summarized above, embodiments are directed to various improvements to interactive media experiences, particularly those in which virtual character dialog is generated via a response model (e.g., a large language model) or other machine learning system. As such, in order to facilitate a better understanding of embodiments of the present disclosure, exemplary interactive media experiences are described below with reference to FIGS. 1 and 2.

FIG. 1 shows a block diagram of an interactive media experience system. A user 102 can engage with the interactive media experience (e.g., an AR or VR game, a videogame, a visual novel, AI-based personal assistant, etc.) via a user device 104 (such as a smartphone, videogame console, tablet, laptop, desktop computer, kiosk or computer terminal in a theme park, laser tag system, etc.). Such a user device 104 could comprise a screen and display elements of the interactive media experience (e.g., virtual characters and environments) and can additionally comprise a speaker which can play audio corresponding to the interactive media experience (e.g., character dialog, sound effects, etc.). Further, the user device 104 can include a microphone that can be used to capture user speech data from the user 102. For example, as part of an interactive media experience, the user 102 could speak to a virtual character displayed on the user device 104, and the user device 104 could capture that speech via a microphone.

As part of the interactive media experience, the user device 104 can communicate with a computer system 108 (e.g., a server computer managing or otherwise providing aspects of the interactive media experience over a communication network 106. A communication network such as communication network 106 can take any suitable form, and may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between computers and devices in the system of FIG. 1 and/or over communication network 106 may be transmitted using a secure communication protocol, such as, but not limited to, File Transfer Protocol (FTP); HyperText Transfer Protocol (HTTP); Secure HyperText Transfer Protocol (HTTPS); Secure Socket Layer (SSL), ISO (e.g., ISO 8583) and/or the like. Any suitable communication protocol can be used to communicate over the communication network 106, e.g., for the purpose of creating one or more communication channels. A communication channel may, in some instances, comprise a secure communication channel, which may be established in any known manner, such as through the use of mutual authentication, a session key, and establishment of a Secure Socket Layer (SSL) session.

Generally, user device 104 can transmit the user speech data to computer system 108 over the communication network 106. Computer system 108 can then perform a response generation method 110 to generate an audio response to the user speech data, e.g., speech by a virtual character that is responsive to speech by the user 102. This response can be transmitted back to user device 104 via communication network 106. The user device 104 can then play the response back to the user 102, e.g., via a speaker. Alternatively, if the response is textual, the user device 104 could display the response to the user on a screen.

FIG. 2 shows a point-of-view of an exemplary AR game played by a user using a smartphone user device 202. The user device 202 can comprise a screen 204 on which a scene is depicted. The scene can incorporate both real elements (e.g., tree 206, captured via a camera element on the back of the user device 202, which is not pictured) and virtual elements, such as friendly virtual character 208 and monstrous virtual character 210. The user device 202 can also comprise a microphone 212 and a speaker 214. User speech (e.g., “Look out!”) can be captured by the microphone and a response can be generated, e.g., as described above with reference to FIG. 1. This response (e.g., “Oh no! The monster has found us!”) can be played back to the user via speaker 214. By communicating with friendly virtual character 208 in this manner, and by interacting with the AR interactive media experience in other ways (e.g., by tapping screen 204 on the monstrous virtual character 210 in order to defeat the monstrous virtual character) a user can play through the AR game.

### I. Immersion

There are various objectives for designers of interactive media experiences, which often relate to achieving a positive and memorable experience for users. Many of these objectives relate to the concept of “immersion”, and it is a generally held belief that interactive media experiences are more enjoyable when they are “more immersive” and that designers of such experiences should avoid and mitigate aspects of the experience that are “immersion breaking.”

While “immersion” is a subjective term, it generally relates to the feeling of being “immersed” (e.g., a part of) a media experience, e.g., such that a user feels like they are part of the environment, game, story, etc., that they are experiencing. A player who is “immersed” in an action game might feel more intense feelings of excitement and adrenaline than a non-immersed player, and a user who is “immersed” in communication with an AI-based personal assistant may feel like they are communicating with an actually intelligent being, rather than a computer program. An “immersion break” is some aspect of the interactive media experience that counteracts immersion, usually by drawing the player's attention to the fact that they are engaging with some form of media but are not actually a part of it. Often, immersion breaks result from media experiences contradicting some usually unstated or unconscious “rules of reality” in a way that goes beyond general suspension of disbelief. For example, in a horror videogame, fear of a monster stems from the player's imagined consequences of being found or caught by that monster. But when a player does get caught by the monster and effectively nothing happens to them (other than losing some progress due to a “game over”), the players immersion is “broken”, and they no longer will have the same intense emotional reaction to the gameplay experience of trying to avoid the monster.

In media where a user communicates with virtual characters, immersion breaks may occur when a virtual character responds in a way that contradicts how a user would expect a character to response. While characters in media often have exaggerated personalities that would be unusual or unexpected in daily life, and therefore respond in ways that are generally unusual, there is often still a logical underpinning (if only subconscious) in how a user expects a character to respond. When a virtual character speaks, the user expects the character to communicate in a clear and appropriate tone without unusually long or frequent pauses and with a response that is relevant to either the user's speech or the context of the interactive media experience. As an example, if a user asks a virtual character a question, they generally expect the virtual character to answer the question promptly and appropriately, or at least acknowledge the question and provide some reason to dismiss the question.

As such, when a player communicates with a virtual character, there are ample opportunities for immersion breaking experience or events to occur. Some embodiments of the present disclosure address some of these problems, thereby providing users with more immersive interactive media experiences. Prior to describing systems and methods according to embodiments, these problems and some of the general solutions provided by embodiments of the present disclosure are described below.

Many interactive media experiences rely on scripted, prerecorded, or otherwise predetermined response to inputs by users. For example, Role-playing videogames often use a “dialog tree”, a structure that enables a player to choose to make one of a predefined number of statements, resulting in a corresponding predefined response by non-player character. This unfortunately can be immersion breaking, particularly when the player cannot see themselves agreeing with any of the predefined number of statements. Machine learning models, particularly large language models (LLMs) offer a solution to this problem. A sufficiently powerful machine learning model can generally deliver reasonable responses to a large variety of statements or other inputs made by a user. As such, some embodiments of the present disclosure use a large language “response model” to generate responses to user speech data.

However, communication can be quite complicated, and while machine learning or other AI systems can often generate rational responses, they often cannot communicate those responses in the way that a human would. For example, it can take significant amounts of time for a large language model to generate a response to a statement made by a user. This “latency” may result in large, unnatural pauses between when the user speaks and when a virtual character responds, which may be immersion breaking to a user, as they may draw the user's attention to the fact that they are speaking with, e.g., a computer application and not an actual character. Sometimes utterances (e.g., “hmm”) can be used to “buy time” for an interactive media experience to deliver a response to a user. However, if such utterances are too long, too frequent, or too inappropriate (e.g., given the tone or gravity of the user's statements), they can also be immersion breaking.

Often, interactive media experience systems will wait for a user to complete a statement, then process the entirety of the statement to generate a response, then deliver that response to the user. By contrast, in some embodiments of the present disclosure, a computer system can process parts of user speech data sequentially, enabling the computer system to respond more quickly to the user and reduce the length of conversational pauses. For example, if a user makes statement comprising multiple sentences or separate clauses, the computer system can begin to process and generate a response to the first sentence or clause before the user has finished speaking. In this way, the computer system can greatly reduce the amount of time it takes to initially respond to the user. Further, the computer system's own partial response can give the computer system more time to process the rest of the user's statement, as e.g., five seconds of time needed to play a response to the user's first sentence or clause provide five seconds of time for the computer system to process the remainder of the sentences or clauses.

Further, interactive media experiences based on artificial intelligence may struggle when dealing with interruptions or later user speech that recontextualizes earlier user speech. For example, if a user makes a statement, pauses, then continues that statement, a virtual character may proceed to “talk over” the user in response to the initial part of the statement. Further, if the user's continuation recontextualizes the earlier part of the statement (e.g., “we should go to the store today . . . oh wait, I just forgot I can't go”), then the virtual character's response to the earlier part of the statement may be inappropriate, as it has not yet processed the later part.

Some embodiments of the present disclosure address this problem by using interrupt control methods and by managing the contextual information provided to a response model used to generate responses. Generally, a computer system according to embodiments can mute or otherwise terminate playback of an audio response when it receives additional user speech data. Additionally, if the computer system begins to play an audio response back to the user, then is interrupted, the computer system can remove that response from a “contextual log” input to the response model, in order to prevent the response model from “continuing down a line of conversation” that is no longer appropriate given any new user speech that recontextualizes prior user speech.

Additionally, many interactive media experiences based on artificial intelligence struggle to communicate tonally. Text-to-speech models usually have an associated character or accent (e.g., “Australian Female”, “Chris”, etc.) but will usually speak in a fairly clear monotone. If an AI text-to-speech model does produce a tonal response, it will usually do so unintentionally, e.g., due to bias in the model's training set. For example, a voice actor used to train a model may read a statement such as “I am very angry” in an angry tone of voice, which may result in a text-to-speech model delivering similar statements in an angry tone of voice. However, a text-to-speech model's tone of voice often cannot be controlled, meaning that users are reliant on the model's inadvertent biases for realistic responses. In cases where the tone may change during the course of a statement (e.g., “I am very angry at you, but I forgive you”), a text-to-speech model may adopt either a monotone or an inadvertent “combination of tones”, neither of which is particularly accurate, which may result in an immersion breaking experience for the user.

Some embodiments of the present disclosure address this problem by using a response model that can indicate the tone associated with the semantic response content produced by that response model. These “tonal indicators” can be used to identify relevant text-to-speech models configured to produce audio responses with corresponding tones. For example, instead of producing a textual response such as “Look out, the monster is coming!”, a respond model could produce a textual response that contains tonal indicators, such as “[Scared]Look out, the monster is coming![/Scared]” or “[Sarcastic]Look out, the monster is coming![/Sarcastic]”. A computer system could use the “[Scared]” and “[Sarcastic]” “tags” to identify a corresponding “scared voice” or “sarcastic voice” text-to-speech model, which could then generate an audio response that says “Look out, the monster is coming!” in a scared tone of voice or a sarcastic tone of voice. Combining the use of e.g., LLM response models and multiple different text-to-speech models with different tones in this manner can result in more realistic speech, as sufficiently powerful LLMs can often identify the correct tone and determine realistic dialog (but cannot produce audio dialog), while a single text-to-speech model can often produce realistic-sounding speech (but cannot produce semantic content or effectively identify tone). By using multiple text-to-speech models and a response model that provides “tonal indicators”, embodiments of the present disclosure can deliver realistic and tonally correct dialog, thereby providing a more immersive user experience.

### II. User Device

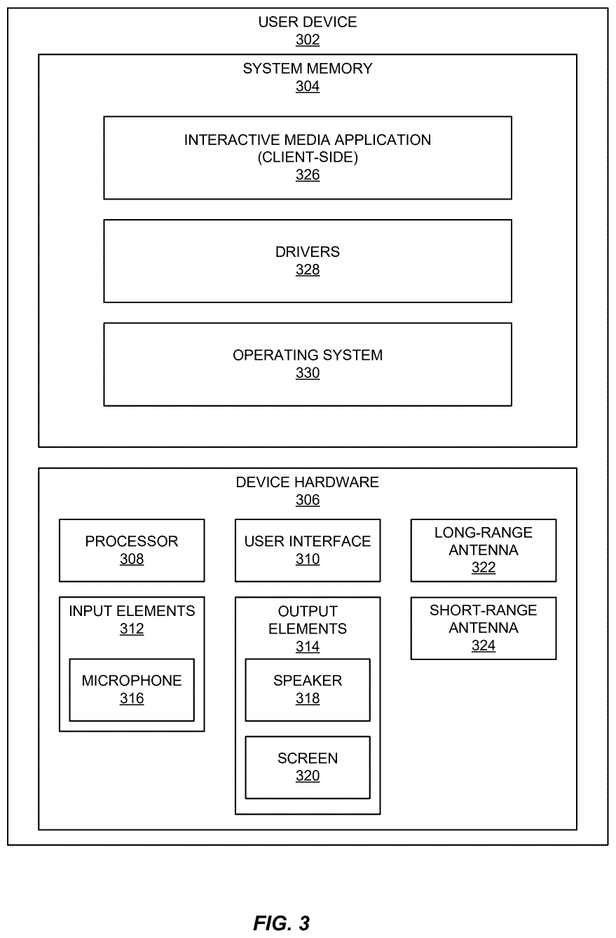

Some systems and methods according to embodiments of the present disclosure may involve a user device, such as a smartphone, laptop, videogame console, table, etc., or any other device by which a user can participate in an interactive media experience (e.g., a kiosk or terminal at a theme park). As such, an exemplary user device 302 is depicted in FIG. 3. The user device 302 can comprise device hardware 306 coupled to system memory 304, which may be implemented using any appropriate memory element, e.g., a hard drive, a solid-state drive, flash memory, etc.

Device hardware 306 may include a processor 308, which may include one or more integrated circuits (e.g., one or more single-core or multi-core microprocessors and/or microcontrollers) and can be used to control the operation of user device 302 and e.g., execute code, programs, or applications stored in the system memory 304, e.g., sequentially or concurrently. Device hardware 306 may also include a user interface 310 (i.e., an interface by which a user can interact with and invoke the functionalities of user device 302, which may additionally comprise input elements 312 and output elements 314. Examples of input elements 312 include microphones (such as microphone 316) keypads, touchscreens, sensors, etc. Examples of output elements 314 may include speakers (such as speaker 318) and display screens (such as screen 320). Device hardware 306 may also include a long-range antenna 322 and a short-range antenna 324. The long-range antenna 322 may include one or more radio-frequency (RF) transceivers and/or connectors that can be used by user device 302 to communicate with other devices and/or to connect with external networks (e.g., a cellular communication network, or the Internet via a wi-fi router or gateway). The long-range antenna 322 may be configured to communicate with a remote base station and a remote cellular or data network, e.g., over radio waves transmitted through the air. The short-range antenna 324 may comprise a contactless interface that can interact with a contactless interface of another device, e.g., using near-field communication (NFC) or other appropriate radio frequency or wireless communication protocols.

The system memory 304 can be implemented using any combination of any number of non-volatile memories (e.g., flash memories) and volatile memories (e.g., DRAM, SRAM), or any other non-transitory storage medium, or any other combination thereof. The system memory 304 may store code, executable by processor 308, for implementing some of the methods described herein or some of the steps of methods described herein. The system memory 304 may store an interactive media application 326, which may be executed by the user device 302 to provide an interactive media experience to a user of user device 302. For example, the interactive media application 326 may comprise an application associated with an augmented reality (AR) videogame, the AR videogame comprising the interactive media experience. As another example, the interactive media application 326 may comprise an application associated with an AI-based personal assistant. The system memory 304 may additionally store a set of drivers 328, which may allow applications (or other programs) stored on the system memory 304 to access device hardware 306 (e.g., enabling the interactive media application 326 to access microphone 316 and speaker 318, in order to listen and respond to user speech). Additionally, the system memory 304 may store an operating system 330, e.g., system software that can manages the device hardware 306 and software resources and can provide common services for programs or applications.

As described above with reference to FIGS. 1 and 2, an interactive media experience according to embodiments may involve a user communicating with a virtual character that is presented to that user in some way. These communications may involve a user device, such as user device 302, recording user speech audio and transmitting that audio (or user speech data derived from that audio, e.g., a transcription of the user speech audio) to a computer system (e.g., a server computer), which can then generate an audio response and return it to user device 302. User device 302 can then play the audio response to the user, e.g., via speaker 318, creating the experience of talking to the virtual character, e.g., as part of a larger “quest” or other gameplay. Various other types of communications or interactions between users and virtual characters are possible in interactive media experiences. For example, a virtual character could respond to user speech by pointing to a particular object (real or virtual) within the interactive media experience or engaging in some form of non-verbal communication (e.g., shrugging their shoulders). Such gestures or non-verbal communications could be displayed to the user while playing a corresponding audio response or could be displayed without any audio response. Additionally, a user could communicate with a virtual character (or otherwise participate in the interactive media experience) via input devices or some sort of user interface, e.g., by “tapping” a virtual character via a touch screen to get the virtual character's attention, by using a gamepad to direct a virtual character (e.g., by tilting a joystick in a direction to cause the virtual character to move in that direction), etc. Various elements of device hardware 306 can be to facilitate communication with a virtual character or otherwise enable a user to engage with an interactive media experience, such as user interface 310, input elements 312, output elements 314, etc.

Interactive media application 326 may perform many of the steps or operations associated with the general interactive media experience described above. For example, interactive media application 326 may comprise code for generating an image or animation of a virtual character and may use a display driver (of drivers 328) to display that virtual character on screen 320. Interactive media application 326 may also comprise code enabling the interactive media application to record audio from a user (e.g., via a driver and microphone 316). Interactive media application 326 may also comprise code enabling the user device 302 to establish communication with a computer system, such as a server computer, which may operate a “server side” interactive media application used to perform other steps or operations associated with the general interactive media experience. In such cases, interactive media application 326 may comprise a “client side” application. Interactive media application 326 may also comprise code enabling the user device 302 to receive an audio response from a computer system (e.g., a server computer), and may further comprise code enabling the user device 302 to play that audio response to the user, e.g., via speaker 318. Interactive media application 326 may call on various functions or services provided by operating system 330 in order to perform some of the steps or operations described above.

At the time of writing, many of the steps or operations associated with generating responses to user speech are computationally expensive. As such, many conventional user devices may lack the ability to, e.g., quickly process user speech data using a large language model to generate a textual output, then generate an audio response using a text-to-speech model. For this reason, a “client-server” system, in which the user device 302 records and replays audio but leaves many other operations to a server computer may be advantageous. However, it is possible that some user devices (e.g., high-end personal computer systems used to play videogames) may possess the computing power needed to use complex large language models. As such and in some embodiments, the interactive media application 326 can perform many of the steps described as being performed by the “computer system” above (further, the user device 302 itself can comprise a computer system). In such embodiments, the interactive media application 326 can comprise code enabling the user device 302 to generate user speech data based on a user audio recording (e.g., a transcription of a user audio recording generated via microphone 316), as well as code enabling the user device 302 to generate a textual response and one or more tonal indicators (as described in further detail below) corresponding to the user speech data. The interactive media application 326 can further comprise code, executable by processor 308, that enables the user device to determine one or more text-to-speech models corresponding to the one or more tonal indicators and generate an audio response to the user speech data using the one or more text-to-speech models. The response model, one or more text-to-speech models, etc., can e.g., be integrated into interactive media application 326 or otherwise stored on system memory 304, or stored or accessed by the user device 302 in any other appropriate manner.

### III. Methods

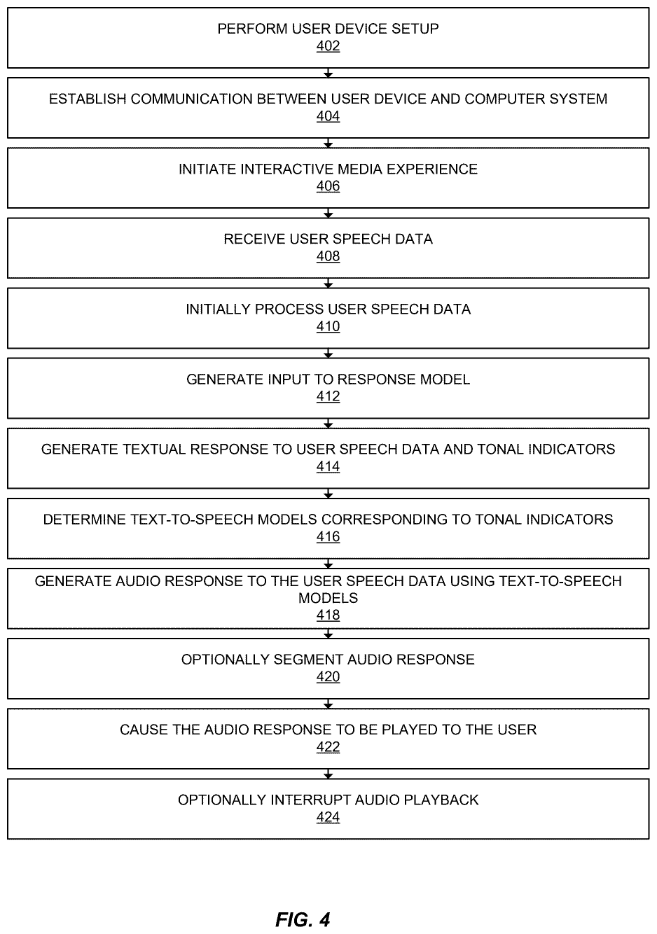

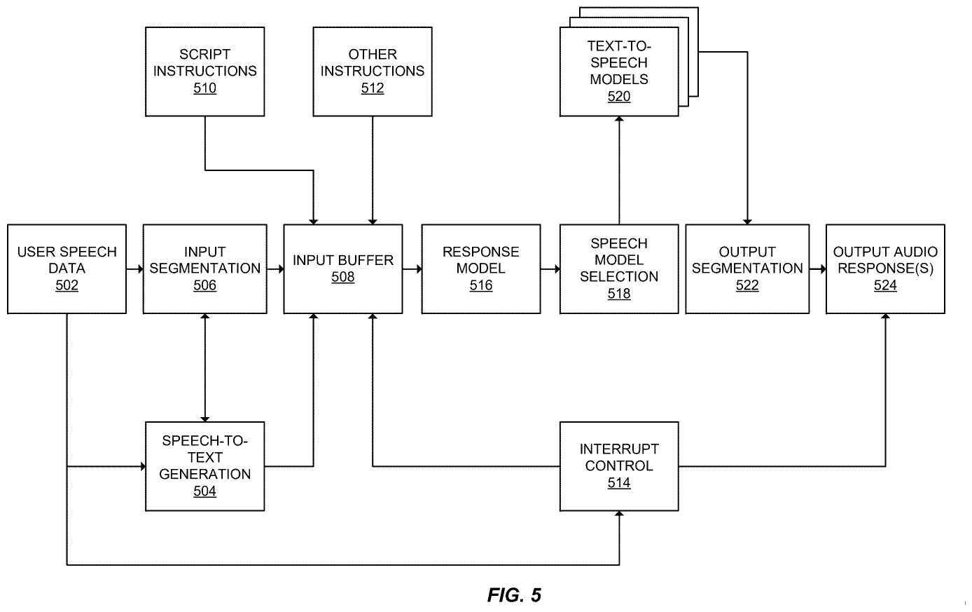

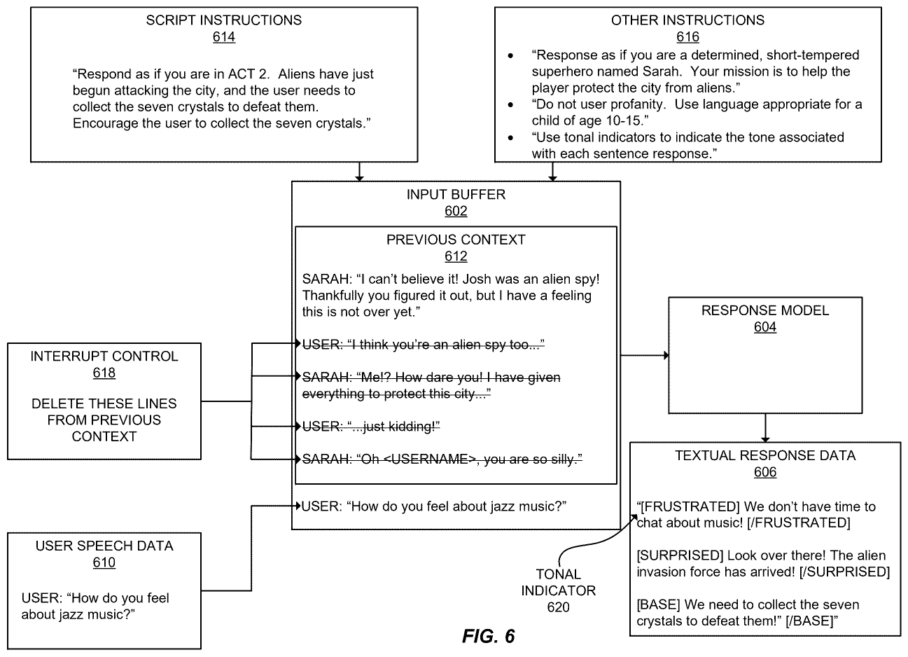

Some methods according to embodiments are described in more detail with reference to the flowchart of FIG. 4, the functional block diagram of FIG. 5, and the diagrams of FIGS. 6-8. Such methods provide various improvements to a large variety of interactive media experiences (e.g., AR or VR games, communication with an AI-based virtual assistant, etc.), particularly those in which a user is audibly communicating with a virtual character. As described above, methods according to embodiments can improve the quality, believability, or “immersiveness” of such communications, particularly by reducing response latency, improving the tonality of audio responses, and managing communication issues that may arise due to interruptions or statement recontextualization. While various examples of interactive media experiences are provided herein, it should be understood that embodiments of the present disclosure can be applied to countless varieties of interactive media experiences, including those that are not explicitly disclosed, and that the examples of interactive media experiences provided herein are non-limiting.

Reference is first made to FIG. 5, which shows various processes, steps, or other aspects of methods according to embodiments, arranged as an interconnected system of blocks. It should be understood that the “system” of FIG. 5 is not intended to depict a particular hardware or software implementation according to embodiments, but is instead intended to comprise a visual aid used to explain various processes or method steps that can be performed by a computer system and/or user device when implementing methods according to embodiments. While a hardware or software implementation of methods according to embodiments could comprise, e.g., a hardware or software “interrupt controller” (corresponding to the interrupt control process block 514 of FIG. 5), it is not strictly necessary. Functions, processes, or method steps associated with process blocks such as the interrupt control process block 514 could be performed by a monolithic software application generally performing methods according to embodiments. Further, in performing some methods according to embodiments, a computer system may not perform any form of “interrupt control” (described in more detail further below) at all. As such and to reiterate, it should be understood that the configuration of labeled elements in FIG. 5 is intended to explain some methods according to embodiments but is not intended to represent a limiting or exact hardware or software architecture for implementing such methods.

Referring to FIG. 4, at step 402 user device setup can be performed, e.g., by a user device and a user operator of the user device. User device setup can take various forms, which can depend on the nature of the user device and the interactive media experience in question. Generally, user device setup can include any steps or processes that are performed in order to enable the user to participate in the interactive media experience via the user device. For example, for an AR game, user device setup may include downloading and installing an AR game application on to their user device. User device setup could additionally include moving or positioning the user device in order to participate in an interactive media experience. For example, a theme park may have a designated location in which guests can play an AR game with other guests, in which case user device setup may include a guest bringing their user device to the designated location. User device setup can also include calibrating or fitting a user device (e.g., a VR headset) or a user establishing an interactive media account (e.g., by setting up a username and password, etc.), or any other appropriate steps or operations that could be performed to enable a user to participate in an interactive media experience.

At step 404, communication can be established between a user device and a computer system. This communication can enable the user device and the computer system to perform method steps according to embodiments. The user device and the computer system can communicate over any appropriate communication network, e.g., as described above with reference to FIG. 1, such as the Internet or a cellular communication network. In some cases, the user device and the computer system may communicate over a wired network or a direct interconnection, e.g., the user device may comprise part of a theme park ride including a screen and user interface positioned in a ride vehicle, which may be wired to a computer system located outside the ride vehicle. The user device can perform any appropriate communication protocol steps in order to establish communication, including “handshaking” or the establishment of a cryptographic key, thereby establishing a secure communication channel.

Further, during step 404 the user device and computer system may establish data streams (e.g., telemetry streams) or exchanges between the two devices. As an example, during an interactive media experience the user device could stream data indicative of the relative position and orientation of the user device (e.g., inferred via gyroscopic sensors in the user device) to the computer system. Additionally, the user device could stream audio data captured from a microphone hardware element of the user device or could stream a textual data stream comprising a textual transcription of such audio data. Further, the user device could stream video data captured from a camera hardware element of the user device. Similarly, the computer system could stream video data (e.g., via webRTC) back to the user device, which could display scenes or other images or animations associated with the interactive media experience. For example, the computer system could stream video data corresponding to scene similar to the scene depicted in FIG. 2, e.g., comprising virtual characters that can be superimposed over video captured from a user device camera. Telemetry data received from the user device and e.g., relating to the size and orientation of the user device, can be used by the computer system to determine the correct size and orientation of the virtual characters in the streamed video data. Further, the computer system and user device can also establish an audio stream to the user device, e.g., comprising audio responses to user statements corresponding to virtual characters.

At step 406, the interactive media experience can be initialized or otherwise started. A user could, e.g., select a button or other input element to indicate which interactive media (of several choices) that they wish to experience and e.g., select a “difficulty level” (e.g., in the case of a game). Similarly, the user could input or record a preferred username. The user device could further provide initial telemetry data to the computer system, such as the orientation and position of the user device. These data as well as other data (e.g., script data corresponding to an interactive media experience) can be used by the computer system to initialize the interactive media experience, e.g., by establishing a scene, story, and characters, and by enabling the computer system to stream video or audio to the user device, such that user sees and hears the scene and characters (e.g., as depicted in FIG. 2) and is e.g., delivered exposition (e.g., audibly or in the form of displayed text) that establishes the story. In the case of an interactive game, text or audio streamed to the user device may indicate or remind the user of the game's rules or objectives.

In some cases, much of the data used in the interactive media experience may be already stored on the user device, e.g., as part of a client-side interactive media application. In such cases, rather than streaming such data itself (e.g., video data representative of virtual characters), the interactive media application could stream resource identifiers or other information (e.g., position, orientation, and animation information), which could be used by the user device to retrieve the corresponding data and use that data to construct the scene. For example, the computer system could stream an instruction to “play an opening cutscene”, and the user device could identify and retrieve a video file corresponding to the opening cutscene then display it on the user device screen. This may be useful for environments in which a slow network prohibits streaming large volumes of information to user devices.

At this point, the user can begin engaging with the interactive media experience, e.g., by communicating with the virtual characters. To this end, at step 408, the computer system can receive user speech data corresponding to a user. The computer system can receive this user speech data from the user device. The user device can comprise a microphone and can record a user audio recording using the microphone. The user speech data can comprise the user audio recording. Alternatively, the user speech data can comprise textual user speech data generated by the user device using the user audio recording. Many smartphone user devices include dictation software that can enable a user to e.g., compose a text message without using their hands. An interactive media experience application on the user device could use an application programming interface (API) or other appropriate means to access such dictation software and convert any such user audio recordings to textual user speech data. Various codecs, such as AAC or FLAC could be used to stream audio user speech data from the user device to the computer system.

As described above, methods according to embodiments can be used to reduce latency between when a user finishes speaking and when an audio response (corresponding, e.g., to a virtual character) is delivered. As described above, this reduction can be achieved, in part, by beginning to generate responses to user speech before the user has finished speaking, e.g., by generating a response to a first statement, sentence, or clause presented by the user, then generating a response to a second statement, sentence, or clause presented by the user, and so forth, until responses have been generated for the entirety of the user's speech. This “piecemeal processing” can enable the computer system to respond much more quickly to the user, reducing the latency between when the user finishes speaking and when the system responds. To this end, the user speech data may be representative of part of a continuing user speech, for example, if the user stated “hello, my name is John, nice to meet you”, the user speech data could comprise an audio recording corresponding to the statement “hello, my name is John”. After receiving this user speech data, the computer system could receive user speech data corresponding to the subsequent statement “nice to meet you”.

In some embodiments, the user device can use any appropriate means to segment audio recordings or otherwise prepare and send user speech data corresponding to segments of user speech to the computer system. For example, an interactive media application on the user device may use signal processing techniques to identify a brief pause in user speech (e.g., corresponding to a “comma”, “hyphen”, “or ellipses” between separate clauses or statements), and send user speech data recorded prior to that pause as a single element of user speech data, later transmitting user speech data corresponding to statements made after the pause to the computer system. Alternatively, the user device could stream audio user speech data, e.g., according to a set or predefined bitrate, such as 192 kilobits per second. Such a bitrate could be variable based on the quality of the connection between the user device and the computer system. In such cases, the user speech data could comprise the data communicated by one or more TCP segments, one or more IP packets, etc., which are transferred between the user device and the computer system as part of user speech data stream. Sending the user speech data in smaller “chunks” can allow the computer system to process these chunks independently, enabling the computer system to return an audio response to e.g., earlier segments of user speech data before it has finished processing the entirety of the user's speech, thereby improving latency. The computer system or the user device (e.g., via an interactive media application) can establish features defining the size of an element of user speech data (e.g., a number of words, a length of an audio recording, etc.), which could be fixed or changing during the course of an interactive media experience (e.g., if a change in network connectivity necessitates a reduction in the bitrate of a user audio stream from the user device to the computer system).

Reference is now made to both FIGS. 4 and 5. At step 410, if necessary, the computer system can perform any appropriate initial processing operations on the user speech data. Such initial processing operations may generally comprise operations enabling the computer system to generate a textual response to the user speech data (and one or more tonal indicators) using a response model 516. For example, if the user speech data comprises a user audio recording, in some embodiments, the computer system can transcribe the user audio recording, thereby generating textual user speech data. Such textual user speech data could then be input into the response model 516 in order to generate a textual response to the user speech data and one or more tonal indicators. The computer system can use speech-to-text generation processes 504 to generate textual user speech data, e.g., using any appropriate automatic speech recognition method, such as those based on hidden Markov models, neural networks, etc.

Further, if necessary, the computer system can segment the user speech data into a plurality of segments of user speech data, e.g., if such segmentation was not performed by the user device, or e.g., if the segments of user speech data produced by the user device are still too large (in terms of logical size, number of words or characters, etc.) for fast and efficient processing by the computer system. The computer system can employ any appropriate input segmentation process 506 to perform this input segmentation, e.g., segmenting textual user speech data by iterating through an array of characters representative of such textual user speech data, identifying characters associated with pauses or independent statements (e.g., commas, hyphens, or ellipses) and “splitting” such arrays based on the locations of these characters. As another example, the computer system could iterate through a data vector representative of a user audio recording, identify locations in the vector corresponding to “quiet” periods (e.g., corresponding to pauses in user speech) using any appropriate signal processing technique, then segmenting the audio recording based on those identified pauses.

A large variety of other initial processing operations could be performed, and the examples provided above and below are intended to be non-limiting. As another example, if the user speech data is “garbled”, e.g., due to significant background noise, initial processing operations could involve techniques used to remove noise from the user speech data, which could include either audio noise that can be removed using any variety of denoising technique, or “semantic noise” in a transcription of the user speech data, which could be removed, e.g., using a neural network trained to “predict” the content of noisy user speech data. As another example, for quiet user speech data, the computer system could perform initial processing operations that amplify the user speech data, e.g., prior to transcribing it using speech-to-text generation process 504, presumably improving the accuracy of the produced textual user speech data.

At step 412, the computer system can generate an input to the response model 516. Such an input could be stored in an input buffer 508. The input can comprise any data the response model 516 can process in order to generate a textual response to the user speech data and one or more tonal indicators. These data can include the user speech data itself. In some embodiments, the response model 516 can comprise a large language model (LLM) that can generate a response to a textual “prompt” provided to response model 516. Such a prompt could include the user speech data and a tonal instruction instructing the large language model to generate one or more tonal indicators in addition to the textual response. Later, e.g., at step 414, the computer system can input the prompt into the large language model, thereby generating the textual response and the one or more tonal indicators. Further, as described above, in some embodiments the computer system can be associated with an interactive media experience (e.g., a server computer associated with an AR or VR game, visual novel, virtual assistant, etc.), and a user of the user device can be a participant in the interactive media experience. In such embodiments, the prompt can further comprise instructions instructing a large language model to response to the user speech data in accordance with a character identity and an interactive media experience script. Various data or processes can influence the input to the response model 516, e.g., by adding or removing data from input buffer 508. These can include user speech data itself (e.g., generated from streamed audio via speech-to-text generation processes 504, script instructions 510 (e.g., corresponding to an interactive media experience script), other instructions 512 (e.g., including character identity instructions), as well as interrupt control processes 514, which can be used, e.g., in order to correct any erroneous user speech data or textual responses that may have resulted from interruptions in user speech or user speech data that recontextualizes prior user speech data.

Step 412 may be better understood with reference to the diagram of FIG. 6, which shows an input buffer 602 as well as various data that can be included in the input buffer 602, which can be collectively input into a response model 604 in order to generate textual response data 606 (which may include tonal indicators such as tonal indicator 620). In the example of FIG. 6, script instructions 614 and other instructions 616 define a character (a superhero named “Sarah”) and a scene (an alien attack) for an interactive game. These instructions can be included in the input buffer 602 and can instruct response model 604 to respond to user speech data in a manner consistent with the scene and character, and e.g., consistent with any “content or age-appropriate criteria” (e.g., responding in a manner that would be appropriate for a child or young teenager. Additionally, the other instructions 616 can include instructions that the response model 604 should use include tonal indicators in textual response data 606 generated by the response model 604, and that the response model 604 should attempt to infer and match the user's tone via such tonal indicators. Further, the input buffer 602 can include previous context 612, e.g., a log of previous dialog exchanges between the user and the virtual character represented by response model 604. Additionally, input buffer 602 can include recently received user speech data 610, on which generated textual response data 606 can be based. Further, input buffer 602 can include any additional prompts or instructions enabling the response model 604 to interpret any other data included in input buffer 602, e.g., a statement such as “A record of previous conversations with the user is as follows:” could precede the previous context 612, or an instruction such as “respond to the user's most recent statement” could precede the user speech data 610.

As described above, and described in more detail further below, interrupt control can be used to deal with communication issues that may arise due to inordinately long pauses in user speech (e.g., resulting in interruptions or recontextualization of user speech). In the example of FIG. 6, in the previous context 612, the user jokingly implies that the virtual character is an alien spy, but then pauses for too long before indicating that the statement was a joke. This leads to a series of responses that are not particularly relevant to further communication between the user and the virtual character. As such, the computer system can perform interrupt control processes 618 to remove these statements from the previous context 612 in order to prevent these statements from polluting subsequently generated textual response data 606.

In embodiments, various instructions or other inputs to the response model 604 can be generated, and the examples provided herein are intended to be non-limiting. Further, instructions can change throughout the course of an interactive media experience. For example, as implied in the exemplary script instructions 614, the interactive media experience may be divided into different “acts”, and a different set of script instructions 614 may be provided to the response model 604 in a different act. Further, certain words or phrases by the user may trigger modifications to the instructions provided to the response model 604. For example, if the user provides a password, indicative that they have achieved some goal in an interactive game, the response model 604 may be instructed to response as if that user was in a different act or part of that interactive game.

FIG. 6 shows exemplary textual response data 606, which shows textual data including the textual response (e.g., the semantic content of the response), as well as in-line tonal indicators (e.g., tonal indicator 620) indicating the tone of sections of the response. Various forms of tonal indicators can be used in embodiments of the present disclosure, including e.g., tonal indicators similar to tags in a markup language such as XML, hashtags, etc., or e.g., diacritical marks located over words in the textual response that can be mapped to particular tones. Some examples of tonal indicators are provided further below.

Referring back to FIGS. 4 and 5, at step 414 the computer system can generate a textual response to the user speech data and the one or more tonal indicators based on the user speech data and using a response model (e.g., response model 516). The computer system can do so by generating an input to the response model, e.g., as described above with reference to FIG. 6 and provide this input to the response model, e.g., by passing data (including user speech data) stored in an input buffer into the response model. As described above, the response model can comprise a large language model that can interpret and response to general purpose queries, e.g., “response to the following statement as if you are . . . ”, e.g., as described above with reference to FIG. 6. As described above, in some embodiments the response model can correspond to a character in an interactive media experience, e.g., a “non-player character” (NPC) in a video game or a virtual personal assistant.

As described above, in some embodiments, the computer system can generate a textual response and the one or more tonal indicators by generating textual response data comprising the textual response and the one or more tonal indicators, e.g., as depicted in FIG. 6, e.g., in which the one or more tonal indicators comprise in-line “tags” indicating the tone of corresponding segments of the textual response. More generally, in some embodiments the one or more tonal indicators can comprise textual elements indicating one or more tones associated with one or more words or utterances (e.g., filler such as “um” or “hmm”) represented by the textual response data. These words or utterances can comprise the textual response. For example, as depicted in FIG. 6, the textual response data 606 includes the passage “[FRUSTRATED] We don't have time to chat about music![/FRUSTRATED]” and in this example, the texts “[FRUSTRATED]” and “[/FRUSTRATED]” can comprise tonal indicators, while the text “We don't have time to chat about music!” can comprise one or more words or utterances.

Generally, a tonal indicator can indicate a tone of one or more words or utterances preceding the tonal indicator, following the tonal indicator, containing the tonal indicator, or between the tonal indicator and a corresponding tonal indicator. As an example, in the statement “Let's go! #Happy”, the tonal indicator “#Happy” can indicate that the one or more words or utterances preceding the tonal indicator (“Let's go!”) should be expressed in a happy tone. As another example, in the statement “T0023 Run now!” the tonal indicator T0023 can indicate that the one or more words or utterances following the tonal indicator should be expressed in a particular tone mapping to the numerical code of the tonal indicator (“T0023”). As another example, in the statement “[Base]I've got to go to work[/Base]”, the tonal indicator “[Base]” can indicate that one or more words (“I've got to go to work”) or utterances between the tonal indicator and a corresponding tonal indicator (i.e., [/Base]) should be expressed with a base, neutral, or default tone. As another example, in the statement “\tilde{h}\tilde{e}\tilde{l}\tilde{l}\tilde{e}”, the tonal indicators contained in the one or more words or utterances, i.e., the ~accent marks contained in the word “hello” can indicate a tone associated with the word “hello”, which could be identified, e.g., from a lookup table matching diacritic marks to their corresponding tone.

As described above, in some embodiments a computer system can perform piecemeal or stream processing of user speech data to generate audio responses, thereby reducing latency between when a user finishes speaking and when an audio response is played back to the user. To this end, and as described above with reference to step 410 and input segmentation process block 506, in some embodiments the computer system can segment user speech data into a plurality of segments of user speech data (or e.g., receive user speech data from a user device as a series of segments. As such, in some embodiments the computer system can generate a textual response and a set of tonal indicators corresponding to each segment of user speech data using the response model, thereby generating a plurality of textual responses and a plurality of sets of tonal indicators.

At step 416, the computer system can determine one or more text-to-speech models (e.g., text-to-speech models 520 depicted in FIG. 5) corresponding to the one or more tonal indicators. Alternatively, if there are multiple sets of tonal indicators (e.g., if the computer system generated a plurality of textual responses and a plurality of sets of tonal indicators corresponding to a plurality of segments of user speech data), the computer system can determine one or more text-to-speech models for each set of tonal indicators (which may each correspond to a corresponding sets of tonal indicators. The computer system can use any appropriate speech model selection process 518 in order to determine the one or more text-to-speech models 520. As an example, in some embodiments, to determine one or more text-to-speech models corresponding to the one or more tonal indicators, the computer system can parse textual response data, thereby identifying the one or more tonal indicators and one or more segments of text including the one or more tonal indicators, then determine the one or more text-to-speech models corresponding to the one or more tonal indicators. Optionally, the computer system can then remove each tonal indicator from a corresponding segment of text, in order to prepare the text to be input into a corresponding text-to-speech model.

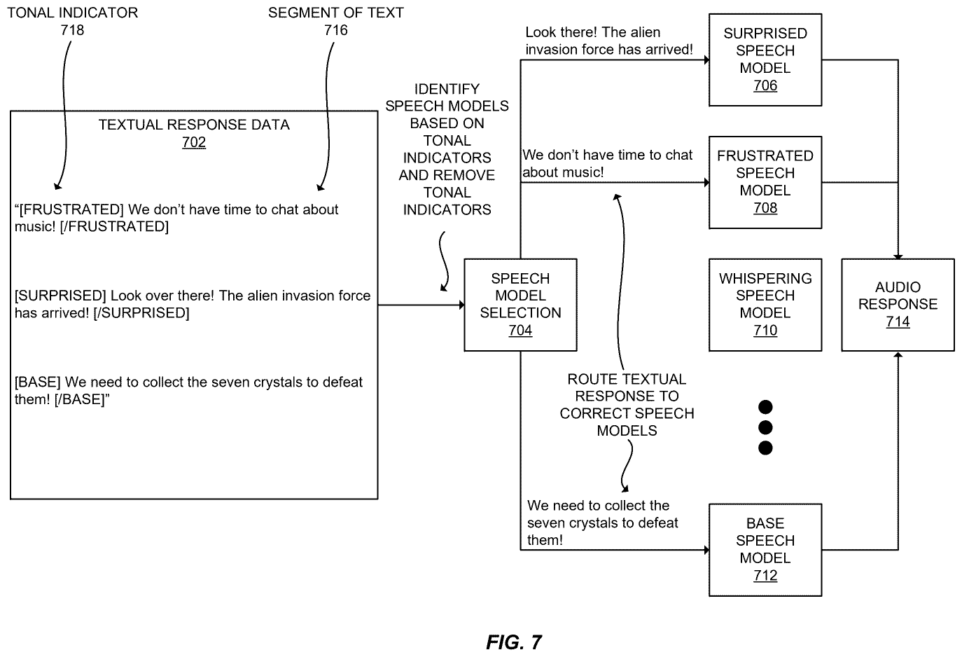

Step 416 may be better understood with reference to FIG. 7, which shows textual response data 702 containing both segments of text (e.g., segment of text 716) and “tag-style” tonal indicators (e.g., tonal indicator 718). As part of a speech model selection process 704, the computer system could identify speech models based on the tonal indicators, e.g., by parsing through the textual response data 702, line-by-line or character-by-character and identifying text corresponding to tonal indicators, e.g., uppercase text contained within brackets (e.g., [FRUSTRATED]). Once the computer system has identified such tonal indicators, it can then identify text-to-speech models based on those tonal indicators, e.g., by using a mapping table or other resource location method to identify one or more text-to-speech models from a collection of text-to-speech models. The computer system can parse through the textual response data 702 in this manner until all textual response data 702 has been processed and all tonal indicators and corresponding text-to-speech models have been identified. It should be understood that the example above is intended only as a single non-limiting example of a speech model selection process 704, and that various other methods or processes can be used to determine or otherwise identify text-to-speech models based on tonal indicators.

FIG. 7 shows four text-to-speech models 706-712, including a surprised speech model 706, a frustrated speech model 708, a whispering speech model 710, and a base speech model 712, e.g., corresponding to the default or neutral tone of voice for a character. As indicated in FIG. 7, the tonal indicators in textual response data 702 correspond to the frustrated speech model 708, the surprised speech model 706, and the base speech model 712. As described above, for textual response data in which tonal indicators are “in line” with the textual response itself, the computer system can remove tonal indicators from corresponding segments of text, prior to inputting those segments of text into their corresponding text-to-speech models. For example, in FIG. 7, the tonal indicators “[FRUSTRATED]” and “[/FRUSTRATED]” were removed from segment of text 716 (“We don't have time to chat about music!”) prior to inputting that segment of text into frustrated speech model 708.

Various text-to-speech models can be used in embodiments of the present disclosure, including text-to-speech models trained by a practitioner of methods according to embodiments (e.g., an owner or operator of a computer system performing methods according to embodiments). For example, an operator of computer system could hire a voice actor (or act as one themselves) in order to generate training data that could be used to train the text-to-speech models. The voice actor could be given a description of a virtual character in an interactive media experience and record lines of dialog as that virtual character. These recorded lines of dialog, and e.g., transcriptions of the dialog could be used as training data for the text-to-speech models, e.g., a loss function could be used to compare audio produced by the text-to-speech models to the recorded dialog audio, which could then be used to train the text-to-speech models, e.g., using methods such as stochastic gradient descent. The voice actor could record dialog in different tones of voice in order to train different text-to-speech models. For example, to train surprised speech model 706, the voice actor could record lines of dialog in a surprised tone of voice, and to train whispering speech model 710, the voice actor could record lines of dialog in a whisper.

In some embodiments, tonal indicators can indicate a “mix” of tones, e.g., [70% FRUSTRATED 30% SURPRISED], indicating that a segment of text should be expressed in a manner that is 70% frustrated and 30% surprised tone. In such embodiments, the computer system can determine or identify a mix or ensemble of text-to-speech models in order to generate an audio response (e.g., audio response 714) that has the desired mix of tones. There are various ways that this could be accomplished. For example, if the text-to-speech models have the same general structure (e.g., equal numbers of model parameters in a one-to-one correspondence), the computer system could generate a new text-to-speech model comprising a weighted average of the model parameters corresponding to text-to-speech models determined via the tonal indicators, e.g., a model comprising a 70-30 weighted average of the frustrated speech model 708 and the surprised speech model 706.

Referring to FIGS. 4 and 7, at step 418, the computer system can generate an audio response (e.g., audio response 714) to the user speech data using the one or more text-to-speech models (e.g., text-to-speech models 706-712). In some embodiments, the computer system can input each segment of text from one or more segments of texts into a corresponding text-to-speech model of the one or more text-to-speech models, thereby generating one or more partial audio responses. For example, as depicted in FIG. 7, the segment of text “Look there! The alien invasion force has arrived!” can be input into surprised speech model 706 to produce one partial audio response, while segment of text “We don't have time to chat about music!” can be input into frustrated speech model 708 to produce another partial audio response. The computer system can then combine these partial audio responses (in addition to any other partial audio responses) to generate audio response 714. For example, the computer system could concatenate audio data vectors corresponding to each partial audio response together sequentially, thereby generating audio response 714. The computer system can combine the partial audio responses in any appropriate manner to generate audio response 714 and can also perform additional audio processing operations to generate a more “natural” or “pleasing” audio response, e.g., mixing audio responses by “fading out” one audio response and “fading in” a subsequent audio response, thereby eliminating any jarring “hard cut” effects that can arise from mixing audio.

Alternatively, and as described above, in some embodiments tonal indicators may indicate a mix of tones corresponding to a textual response, e.g., “30% happy 70% excited”. In such embodiments, the computer system could generate a combined text-to-speech model comprising a combination of the one or more text-to-speech models and generate the audio response by inputting user speech data into the combined text-to-speech model, e.g., as described further above with reference to step 416. The computer system could, for example, determine a combined text-to-speech model as a weighted average of the parameters of two or more text-to-speech models, e.g., if those text-to-speech models comprise parameters in one-to-one correspondence. As described above, the response model may correspond to a character in an interactive media experience and each text-to-speech model can correspond to the character speaking in a corresponding tone of voice of one or more tones of voices (e.g., a surprised tone of voice, a frustrated tone of voice, a whispering tone, a base or neutral tone of voice, etc.). As described above, in some embodiments, each text-to-speech model of the one or more text-to-speech models can be trained using a plurality of audio recordings of voice actor dialog corresponding to the one or more tones of voices. For example, a happy text-to-speech model can be trained using recordings of a voice actor reading lines with a happy tone of voice, while an angry speech model can be trained using recordings of a voice actor reading lines with an angry tone of voice. Different text-to-speech models may have different output statement lengths or utterance lengths. For example, a happy or excited text-to-speech model may generate short “bursts” of speech, whereas a whispering text-to-speech model may produce longer continuous statements.

As described above, in some embodiments a computer system can perform piecemeal or stream processing of user speech data to generate audio responses, thereby reducing latency between when a user finishes speaking and when an audio response is played back to the user. To this end, the computer system may have generated a plurality of textual responses (e.g., at step 414) or may be continuously generating textual responses. In such cases, the computer system can generate an audio segment response to a corresponding segment of user speech data for each textual response using one or more text-to-speech models corresponding to a corresponding set of tonal indicators, thereby generating a sequence of audio segment responses. As described further below with reference to step 422, this sequence of audio segment responses can be played sequentially to the user, and can in some cases, provide the computer system with more time to process user speech data, e.g., by enabling the computer system to generate a textual response to a given segment of user speech data while delivering an audio response to a previously received segment of user speech data.

Optionally, at step 420, the computer system can segment the audio response into a plurality of sequential audio responses. The computer system can use any appropriate means to do so. For example, the computer system can use signal processing techniques to identify one or more pauses in the audio response (e.g., brief periods of silence between response statements) and segment the audio response based on the one or more pauses, thereby generating a plurality of sequential audio responses. As another example, the computer system could identify one or more pauses in the textual response based on one or more textual characters indicative of pauses in speech (e.g., punctuation such as commas, hyphens, ellipses, etc.). The computer system can then segment the audio response based on the one or more pauses (e.g., by identifying corresponding locations within a response audio vector), thereby generating the plurality of sequential audio responses.

Various other methods and criteria can be employed to segment audio responses in methods according to embodiments, and the examples provided above are intended to be non-limiting. As another example, the computer system could segment an audio response based on network or latency considerations, e.g., segment audio responses in order to minimize latency between when a user finishes speaking and when the computer system delivers an audio response (or a segment of an audio response) to that user. For example, perhaps an audio stream bitrate of 192 kbps only enables a transmission of approximately twenty words per second, and therefore the computer system may segment audio responses such that each audio response segment comprises twenty words or less. The computer system could change the segmentation rate based on changes in network conditions or latency, e.g., if the bitrate is reduced, the computer system may generate smaller audio response segments. As another example, if the computer system has built up a large “time buffer”, e.g., because 30 seconds, a minute, two minutes, etc. of audio responses are “queued up” to be played to the user, then the computer system may generate larger audio segment responses in order to more efficiently transfer data to a user device, as latency is less of a concern. Segmentation of audio responses may not be necessary in various embodiments of the present disclosure, e.g., if user speech data had been segmented prior to generating textual and audio responses, as such audio responses may already be an appropriate length for low latency user playback. As such, it should be reiterated that step 420 is optional.

At step 422, the computer system can cause an audio response (or e.g., a plurality of sequential audio responses) to be played to a user, e.g., via a user device from which the computer system received the user speech data. In some embodiments the user device can comprise a speaker, and in such embodiments, causing the audio response to be played to the user can comprise transmitting the audio response to the user device, which can then play the audio response to the user via the speaker. The computer system can transmit the audio response to the user device via any appropriate means, protocol, or communication network (e.g., the Internet or a cellular communication network). In some embodiments, the computer system can transmit the audio response to the user device via a communication channel established by the computer system and the user device, e.g., at step 404. Alternatively, and if applicable, the computer system can cause the audio response to be played to the user by sequentially transmitting each sequential audio response (also referred to as a “sequence of audio segment responses”) to the user device and the user device can sequentially play the plurality of sequential audio responses to the user.

Various factors may influence the “timing” of transmissions of audio responses to the user device. For example, the computer system may wait until the user has finished speaking before transmitting any audio responses to the user device. The computer system may detect that the user has finished speaking via, e.g., detecting periods of silence in streamed audio data from the user device or e.g., by detecting a pause or termination in the transmission of user speech data (e.g., transcribed from recorded user audio) from the user device to the computer system, or via any other appropriate means.

The audio response data can be transmitted to the user device either with, or separately from other data that may be transmitted to the user device as part of an interactive media experience. For example, the computer system may stream video data corresponding to a given scene or instance in the interactive media experience to the user device, e.g., video data corresponding to virtual characters in the interactive media experience, e.g., as depicted in FIG. 2. Response data may be streamed along with this video data in order to prevent or mitigate desynchronization between audio and video (e.g., of virtual characters delivering dialog), but may also be transmitted independently, depending on the particular interactive media experience, network or communication configurations, etc.

It should be understood that many of the steps described above with reference to FIGS. 4-7 can be performed concurrently for different segments of user speech data. A computer system could generate a first textual response corresponding to a first segment of user speech data along with one or more first tonal indicators, then generate a first audio response using one or more first text-to-speech models corresponding to the one or more first tonal indicators. Likewise, a computer system could receive a second segment of user speech data corresponding to a user, generate a second textual response to the second segment of user speech data and one or more second tonal indicators (based on the second segment of user speech data), determine one or more second text-to-speech models corresponding to the one or more second tonal indicators, generate a second audio response to the user speech data and cause the second audio response to be played to the user. The computer system could perform steps concurrently for the first segment of user speech data and the second segment of user speech data. For example, the computer system could generate the second textual response while generating the first audio response, or could, e.g., perform at least one of the steps of generating the second textual response, determining the one or more second text-to-speech models, or generating the second audio response prior to causing the first audio response to be played to the user. In doing so, the computer system could reduce latency by continuously processing received user speech data, thereby efficiently using processing time.

The computer system may use any appropriate means to concurrently perform method steps described herein. For example, the computer system may perform method steps using multiple CPU threads or separate cores of a multicore processor. As another alternative, the computer system may comprise a distributed computing system, e.g., comprising multiple computers. Each computer in the computer system could handle one or more tasks or processes associated with methods according to embodiments, e.g., corresponding to the process blocks depicted in FIG. 5. For example, one computer could perform method steps associated with generating textual responses, while another computer could perform method steps associated with generating audio responses, thereby enabling the computer system to simultaneously generate textual responses and audio responses. Further, if the computer system is associated with a large-scale interactive media experience, e.g., a “massively multiplayer” VR or AR game, the computer system may process user speech data received from multiple users simultaneously and could comprise a large cluster of server computers configured to perform methods according to embodiments.

At step 424, if necessary, the computer system can optionally interrupt audio playback to the user. This could occur e.g., if a user has interrupted a virtual character in the interactive media experience (or alternatively if the virtual character has interrupted the user). In some embodiments, upon receiving additional user speech data (e.g., from continued or interrupting speech by a user), the computer system can terminate sequentially transmitting a plurality of sequential audio responses to the user device in response to receiving the additional user speech data. In this way, the computer system can cause the user device to terminate sequentially playing the plurality of sequential audio responses to the user. Alternatively, the computer system could transmit a “termination signal” or another appropriate message to the user device, which could cause the user device to e.g., mute its speaker system, thereby terminating the playback of audio responses to the user. In these ways the computer system can resume listening to the user and avoid “talking over” the user.

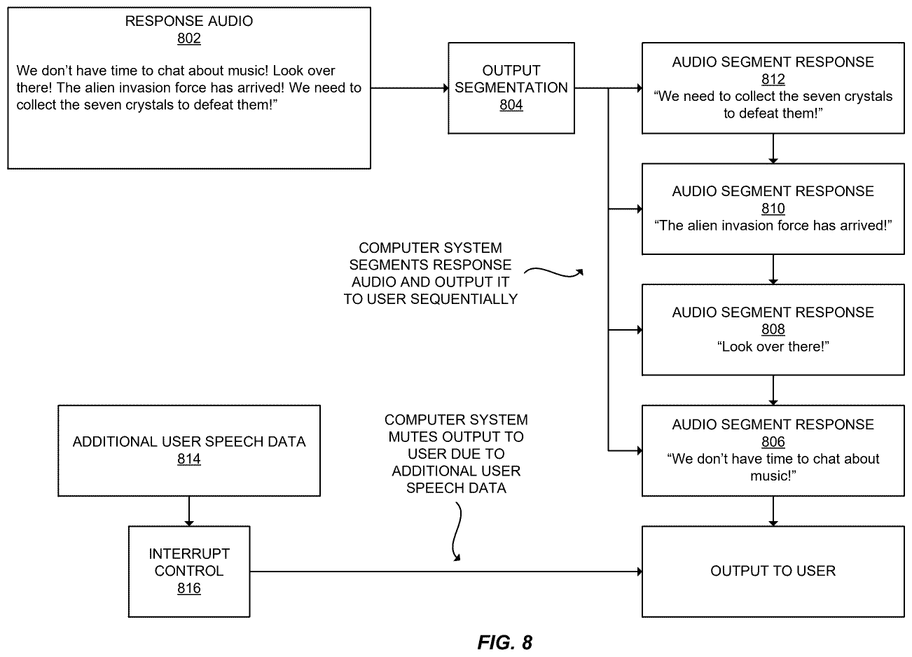

Steps 420-424 can be better understood with reference to the diagram of FIG. 8. As described above, response audio 802 can be split into audio segment responses 806-812 via an output segmentation process 804 (e.g., in which the computer system segments the response audio 802 based on brief pauses in the response audio 802). Audio segment responses 806-812 can be “queued” and output to the user sequentially, e.g., by transmitting the audio segment responses 806-812 sequentially to the user device, such that the user device plays those audio segment responses sequentially to the user, e.g., via a speaker. Upon receiving additional user speech data 814, the computer system can perform an interrupt control process 816 in order to mute or otherwise prevent the output of further audio segment responses to the user. For example, if the computer system had transmitted audio segment responses 806 and 808 to the user device, then received additional user speech data 814, then the computer system could stop transmission of audio segment responses, and thereby not transmit audio segment responses 810 and 812 to the user device.

As described above with reference to FIG. 6, the computer system may perform further operations associated with interrupt control process 816, e.g., such that the computer system generates subsequent audio responses that are rational in view of any changing contextual information resulting from an interruption or other “conversational issue.” As depicted in FIG. 6, the input to a response model 604 can include previous context 612, which may include previous user speech data and textual responses to that user speech data, and which may be used by the response model 604 as a sort of contextual memory. An interruption or e.g., a later contradiction in user speech data (e.g., a user speaking in agreement then later in their statement realizing that they meant to disagree and correcting themselves) may render some previous audio responses either unnecessary or erroneous. As such, at step 424, the computer system can additionally remove various contextual data from an input buffer (e.g., input buffer 602) in response to receiving (and in some embodiments processing) additional user speech data. The computer system can use any appropriate logic or process to identify and remove contextual data, e.g., removing the last four “lines” of data (e.g., in which a “line” comprises either a segment of user speech data or a textual response segment) corresponding to segments of user speech data or textual response segments received or generated prior to the receipt of additional user speech data, only removing lines of data corresponding to textual response segments, etc. In this way, the computer system can prevent erroneous data from “polluting” subsequent audio responses, thereby producing more reasonable or logical audio responses, and thereby improving the “immersiveness” of the interactive media experience for the user.

The methods described above with reference to FIGS. 4-8 may be performed multiple times throughout the course of an interactive media experience. For example, a user playing a videogame could speak into a microphone in order to communicate with a virtual character, in order to ask the virtual character for the location of the next quest. After receiving an audio response from the virtual character (generated by a computer system, e.g., a server computer connected to a videogame console user device), the user could continue playing the game using more traditional control devices (e.g., a gamepad), e.g., by navigating a player character to the location of a quest and completing it. Afterwards, the player could communicate with a different virtual character and the methods described above could be repeated with any appropriate modifications or variations, e.g., by the computer system providing different script or character instructions to a response model (or by using a different response model), by using a different set of text-to-speech models, etc.

### A. Method Performed by User Device

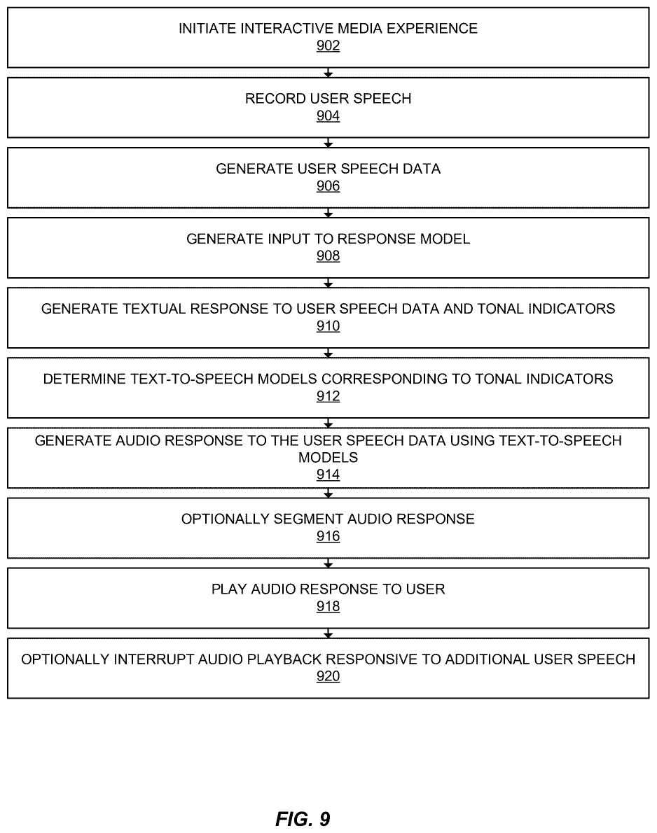

As described above with reference to FIG. 3, many machine learning operations (and therefore many of the method steps described above) are computationally expensive and may exceed the computational capabilities of general-purpose user devices. Consequently, it may be preferable to use a system in which a user device records user speech data and plays audio responses and in which a more powerful server (e.g., a computer system as described above) performs computationally expensive machine learning operations to generate those audio responses. However, it is possible that some user devices (e.g., high-end personal computer systems or smartphones) may possess the computing power needed to quickly and efficiently generate audio responses to user speech data. As such, another embodiment of the present disclosure is directed to a method performed by a user device for generating an audio response and playing the audio response to a user. As described above with reference to FIG. 3, this method could be performed using an interactive media application operating on a user device. This method is described in more detail below with reference to FIG. 9. Many aspects of the steps in the flowchart of FIG. 9 can be understood with reference to the description of similar steps in the flowchart of FIG. 4.

At step 902, the user device can initiate an interactive media experience, and any applicable user device setup can be performed. Many aspects of step 902 may be substantially similar to those described above with reference to steps 402 and 406 of FIG. 4. Generally, user device setup can include any steps or processes that are performed in order to enable the user to participate in the interactive media experience via the user device. For example, for an AR game, user device setup may include downloading and installing an AR game application on to their user device. User device setup could additionally include moving or positioning the user device in order to participate in an interactive media experience. For example, a theme park may have a designated location in which guests can play an AR game with other guests, in which case user device setup may include a guest bringing their user device to the designated location. User device setup can also include calibrating or fitting a user device (e.g., a VR headset) or a user establishing an interactive media account (e.g., by setting up a username and password, etc.), or any other appropriate steps or operations that could be performed to enable a user to participate in an interactive media experience. Additionally, a user could, e.g., select a button or other input element to indicate which interactive media (of several choices) that they wish to experience and e.g., select a “difficulty level” (e.g., in the case of a game). The user device could also establish an initial scene, story and characters and display that initial scene and those characters on a screen of the user device, such that the user sees and hears (e.g., via a speaker) the scene and characters and is e.g., delivered exposition (e.g., audibly or in the form of displayed text) that establishes the story. In the case of an interactive game, text or audio may indicate or remind the user of the game's rules or objectives. Rather than receiving video or audio data (e.g., including three dimensional models of virtual characters) from a computer system and displaying and presenting the interactive media experience to the user (as described above), this data could be stored on the user device itself, e.g., in association with an interactive media application.

After the interactive media experience has been initiated, the user can begin engaging with the interactive media experience, e.g., by communicating with virtual characters. To this end, at step 904, the user can speak to the user device and the user device can record the user, thereby generating a user audio recording, e.g., using a microphone component of the user device.

At step 906, the user device can generate user speech data based on the user audio recording. In some embodiments, the user speech data can comprise the user audio recording itself. In other embodiments, the user speech data can comprise a transcription of the user audio recording. Many smartphone user devices (and other types of user devices) include dictation software that can enable a user to e.g., compose a text message without using their hands. An interactive media experience application on the user device could use an application programming interface (API) or other appropriate means to access such dictation software and convert any such user audio recordings to textual user speech data.

At step 908, the user device can generate an input to a response model. This input can comprise the user speech data, as well as any other data described above, e.g., with reference to FIG. 6, including script instructions, other instructions (such as character instructions), previous context, etc. The user device can additionally segment the user speech data, as needed, in order to generate the input to the response model, e.g., by splitting up the user speech data into two smaller segments of user speech data, including one in the input and using the other for a subsequent input into the response model, thereby reducing the latency associated with providing audio responses to the user. Various other initial processing operations can be performed by the user device at step 908, similar to those described above with reference to FIG. 4, e.g., denoising or amplifying user speech data, etc. As described above, in some embodiments the response model can comprise a large language model and the input to the response model can comprise a textual prompt.

At step 910, the user device can generate a textual response to the user speech data and one or more tonal indicators based on the user speech data and using a response model. The computer system can do so by providing the input generated at step 908 to the response model, e.g., in the form of a prompt held in an input buffer. Textual response and tonal indicators can be understood with reference to the description further above, and descriptions of textual responses and tonal indicators are omitted here for brevity.

At step 912, the user device can determine one or more text-to-speech models corresponding to the one or more tonal indicators. Alternatively, if there are multiple sets of tonal indicators (e.g., if the user device generated a plurality of textual responses and a plurality of sets of tonal indicators corresponding to a plurality of segments of user speech data), the user device can determine one or more text-to-speech models for each set of tonal indicators (which may each correspond to a corresponding sets of tonal indicators. The user device can use any appropriate speech model selection process in order to determine the one or more text-to-speech models. Examples of such speech model selection processes are described further above with reference to e.g., step 416 of FIG. 4, and are omitted here for brevity.

At step 914, the user device can generate an audio response to the user speech data using the one or more text-to-speech models, e.g., by inputting each segment of text from one or more segments of text into a corresponding text-to-speech model of the one or more text-to-speech models, thereby generating one or more partial audio responses. The user device could then combine the one or more partial audio responses in any appropriate manner to generate an audio response. Various processes for generating audio responses and/or combining partial audio responses are described further above with reference to e.g., step 418 of FIG. 4, and are omitted here for brevity.

At step 916 the user device can optionally segment the audio response into a plurality of sequential audio responses, and can use any appropriate means to do so, e.g., using one of the exemplary techniques described above with reference to step 420 of FIG. 4.

At step 918, the user device can play the audio response to the user, e.g., via a speaker. In some embodiments, the user device can play the audio response to the user by sequentially playing a sequence of audio segment responses to the user.

It should be understood that as described above, many of the steps associated with the method of FIG. 9 can be performed concurrently for different segments of user speech data. For example, the user device can e.g., play an audio response to the user while simultaneously generating an audio response to a subsequent collection of user speech data. In doing so, the user device can reduce latency by continuously processing user speech data, thereby efficiently using processing time. The user device can use any appropriate means to concurrently perform method steps described herein, e.g., by simultaneously executing different method steps using different cores of a multicore processor.

At step 920, if necessary, the user device can optionally interrupt audio playback to the user. This could occur e.g., if the user has interrupted a virtual character in the interactive media experience (or alternatively if the virtual character has interrupted the user. In some embodiments, upon receiving additional user speech data (e.g., from continued or interrupting speech by a user), the user device can terminate sequentially playing a plurality of sequential audio responses to the user in response to receiving the additional user speech data. In this way, the user device can resume listening to the user and avoid “talking over” the user. The user device may perform further operations associated with interrupt control processing, e.g., such that the user device generates subsequent audio responses that are rational in view of any changing contextual information resulting from an interruption or other “conversational issue”. These can include, for example, modifying or deleting contextual data from an input buffer in response to receiving (and optionally processing) additional user speech data. Various interrupt control processes can be better understood with reference to the description of step 424 of FIG. 4 above, and descriptions are omitted here for brevity.

The method described above with reference to FIG. 9 may be performed multiple times throughout the course of an interactive media experience. For example, a user playing a videogame could speak into a microphone in order to communicate with a virtual character in order to ask the virtual character for the location of the next quest. After receiving an audio response from the virtual character (generated by a videogame console user device), the user could continue playing the game using more traditional control devices (e.g., a gamepad), e.g., by navigating a player character to the location of a quest and completing it. Afterwards, the player could communicate with a different virtual character and the method described above could be repeated with any appropriate modifications or variations, e.g., by the user device providing different script or character instructions to a response model (or by using a different response model), by using a different set of text-to-speech models, etc.

### IV. Computer System

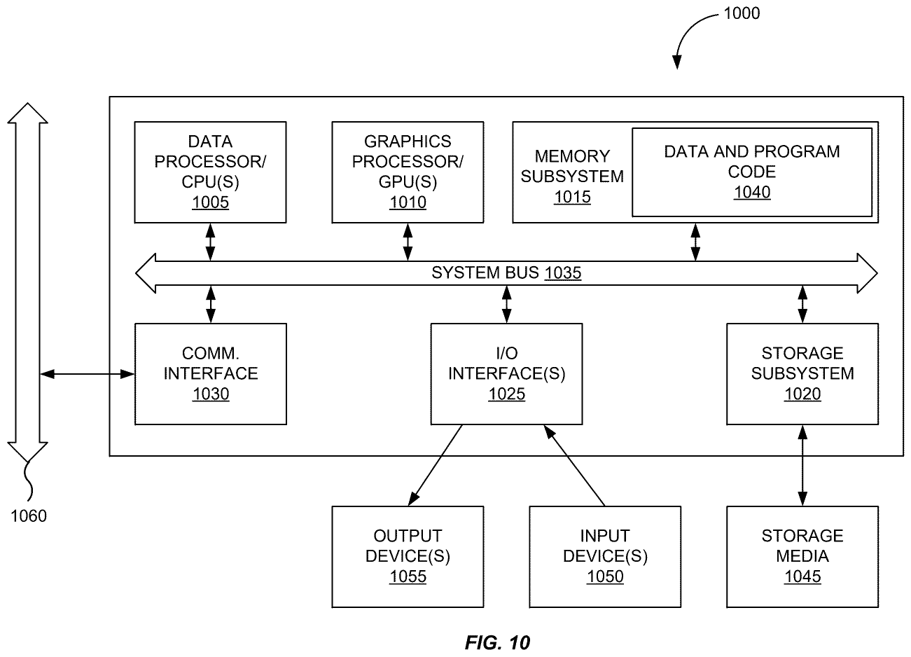

FIG. 10 is a block diagram of computer system 1000. FIG. 10 is merely illustrative. In some embodiments, a computer system includes a single computer apparatus, where the subsystems can be the components of the computer apparatus. In other embodiments, a computer system can include multiple computer apparatuses, each being a subsystem, with internal components. Computer system 1000 and any of its components or subsystems can include hardware and/or software elements configured for performing methods described herein.

Computer system 1000 may include familiar computer components, such as one or more one or more data processors or central processing units (CPUs) 1005, one or more graphics processors or graphical processing units (GPUs) 1010, memory subsystem 1015, storage subsystem 1020, one or more input/output (I/O) interfaces 1025, communications interface 1030, or the like. Computer system 1000 can include system bus 1035 interconnecting the above components and providing functionality, such connectivity and inter-device communication.

The one or more data processors or central processing units (CPUs) 1005 can execute logic or program code or for providing application-specific functionality. Some examples of CPU(s) 1005 can include one or more microprocessors (e.g., single core and multi-core) or micro-controllers, one or more field-gate programmable arrays (FPGAs), and application-specific integrated circuits (ASICs). As used herein, a processor can include a multi-core processor on a same integrated chip, or multiple processing units on a single circuit board or networked.

The one or more graphics processor or graphical processing units (GPUs) 1010 can execute logic or program code associated with graphics or for providing graphics-specific functionality. GPUs 1010 may include any conventional graphics processing unit, such as those provided by conventional video cards. In various embodiments, GPUs 1010 may include one or more vector or parallel processing units. These GPUs may be user programmable and include hardware elements for encoding/decoding specific types of data (e.g., video data) or for accelerating 2D or 3D drawing operations, texturing operations, shading operations, or the like. The one or more graphics processors or graphical processing units (GPUs) 1010 may include any number of registers, logic units, arithmetic units, caches, memory interfaces, or the like.

Memory subsystem 1015 can store information, e.g., using machine-readable articles, information storage devices, or computer-readable storage media. Some examples can include random access memories (RAM), read-only-memories (ROMS), volatile memories, non-volatile memories, and other semiconductor memories. Memory subsystem 1015 can include data and program code 1040.

Storage subsystem 1020 can also store information using machine-readable articles, information storage devices, or computer-readable storage media. Storage subsystem 1020 may store information using storage media 1045. Some examples of storage media 1045 used by storage subsystem 1020 can include floppy disks, hard disks, optical storage media such as CD-ROMS, DVDs and bar codes, removable storage devices, networked storage devices, or the like. In some embodiments, all or part of data and program code 1040 may be stored using storage subsystem 1020.

The one or more input/output (I/O) interfaces 1025 can perform I/O operations. One or more input devices 1050 and/or one or more output devices 1055 may be communicatively coupled to the one or more I/O interfaces 1025. The one or more input devices 1050 can receive information from one or more sources for computer system 1000. Some examples of the one or more input devices 1050 may include a computer mouse, a trackball, a track pad, a joystick, a wireless remote, a drawing tablet, a voice command system, an eye tracking system, external storage systems, a monitor appropriately configured as a touch screen, a communications interface appropriately configured as a transceiver, or the like. In various embodiments, the one or more input devices 1050 may allow a user of computer system 1000 to interact with one or more non-graphical or graphical user interfaces to enter a comment, select objects, icons, text, user interface widgets, or other user interface elements that appear on a monitor/display device via a command, a click of a button, or the like.

The one or more output devices 1055 can output information to one or more destinations for computer system 1000. Some examples of the one or more output devices 1055 can include a printer, a fax, a feedback device for a mouse or joystick, external storage systems, a monitor or other display device, a communications interface appropriately configured as a transceiver, or the like. The one or more output devices 1055 may allow a user of computer system 1000 to view objects, icons, text, user interface widgets, or other user interface elements. A display device or monitor may be used with computer system 1000 and can include hardware and/or software elements configured for displaying information.

Communications interface 1030 can perform communications operations, including sending and receiving data. Some examples of communications interface 1030 may include a network communications interface (e.g., Ethernet, Wi-Fi, etc.). For example, communications interface 1030 may be coupled to communications network/external bus 1060, such as a computer network, a USB hub, or the like. A computer system can include a plurality of the same components or subsystems, e.g., connected together by communications interface 1030 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

In various embodiments, methods may involve various numbers of clients and/or servers, including at least 10, 20, 50, 100, 200, 500, 1000, or 10,000 devices. Methods can include various numbers of communication messages between devices, including at least 100, 200, 500, 1,000, 10,000, 50,000, 100,000, 500,000 or one million communication messages. Such communications can involve at least 1 MB, 10 MB, 100 MB, 1 GB, 10 GB, or 100 GB of data.

Computer system 1000 may also include one or more applications (e.g., software components or functions) to be executed by a processor to execute, perform, or otherwise implement techniques disclosed herein. These applications may be embodied as data and program code 1040. Additionally, computer programs, executable computer code, human-readable source code, shader code, rendering engines, or the like, and data, such as image files, models including geometrical descriptions of objects, ordered geometric descriptions of objects, procedural descriptions of models, scene descriptor files, or the like, may be stored in memory subsystem 1015 and/or storage subsystem 1020. Any operations performed with a processor (or applications executed by a processor) may be performed in real-time. The term “real-time” may refer to computing operations or processes that are completed within a certain time constraint. As examples, a time constraint may be 30 seconds, 1 minute, 10 minutes, 30 minutes, 1 hour, 4 hours, 1 day, or 7 days.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. A method performed by a computer system for generating an audio response, the method comprising:
receiving user speech data corresponding to a user;
generating, using a response model, a textual response to the user speech data and one or more tonal indicators based on the user speech data;
determining, based on the one or more tonal indicators, one or more text-to-speech models corresponding to the one or more tonal indicators;
generating, using the one or more text-to-speech models, an audio response to the user speech data; and
causing the audio response to be played to the user.

2. The method of claim 1, wherein:
the computer system receives user speech data from a user device;
the user device comprises a microphone;
the user device records a user audio recording using the microphone; and
the user speech data comprises the user audio recording or comprises textual user speech data generated by the user device using the user audio recording.

3. The method of claim 1, wherein the user speech data comprises a user audio recording, and wherein generating a textual response to the user speech data and the one or more tonal indicators comprises:
transcribing the user audio recording, thereby generating textual user speech data; and
generating the textual response to the user speech data and the one or more tonal indicators by inputting the textual user speech data into the response model.

4. The method of claim 1, wherein:
the computer system receives the user speech data from a user device;
the user device comprises a speaker; and
causing the audio response to be played to the user comprises transmitting the audio response to the user device, wherein the user device plays the audio response to the user via the speaker.

5. The method of claim 1, wherein the response model comprises a large language model (LLM), and wherein generating the textual response to the user speech data and the one or more tonal indicators comprises:
generating a prompt, the prompt comprising the user speech data and a tonal instruction instructing the large language model to generate the one or more tonal indicators in addition to the textual response; and
inputting the prompt into the large language model, thereby generating the textual response and the one or more tonal indicators.

6. The method of claim 5, wherein the computer system is associated with an interactive media experience, wherein the user is a participant in the interactive media experience, and wherein the prompt further comprises instructions instructing the large language model to response to the user speech data in accordance with a character identity and an interactive media experience script.

7. The method of claim 1, wherein:
generating, using the response model, the textual response to the user speech data and the one or more tonal indicators comprises generating textual response data comprising the textual response and the one or more tonal indicators;
the one or more tonal indicators comprise textual elements indicating one or more tones associated with one or more words or utterances represented by the textual response data;
the one or more words or utterances comprise the textual response; and
a tonal indicator indicates a tone of one or more words or utterances preceding the tonal indicator, following the tonal indicator, containing the tonal indicator, or between the tonal indicator and a corresponding tonal indicator.

8. The method of claim 7, wherein determining, based on the one or more tonal indicators, one or more text-to-speech models corresponding to the one or more tonal indicators comprises:
parsing the textual response data, thereby identifying the one or more tonal indicators and one or more segments of text including the one or more tonal indicators;
determining the one or more text-to-speech models corresponding to the one or more tonal indicators; and
removing each tonal indicator from a corresponding segment of text.

9. The method of claim 8, wherein generating an audio response comprises:
inputting each segment of text of the one or more segments of text into a corresponding text-to-speech model of the one or more text-to-speech models, thereby generating one or more partial audio responses; and
combining the one or more partial audio responses, thereby generating the audio response.

10. The method of claim 1, wherein generating an audio response to the user speech data using the one or more text-to-speech models comprises:
generating a combined text-to-speech model comprising a combination of the one or more text-to-speech models; and
inputting the user speech data into the combined text-to-speech model, thereby generating the audio response.

11. The method of claim 1, wherein:
the response model corresponds to a character in an interactive media experience;
each text-to-speech model of the one or more text-to-speech models corresponds to the character speaking in a corresponding tone of voice of one or more tones of voice; and
the method further comprises: training each text-to-speech model of the one or more text-to-speech models using a plurality of audio recordings of voice actor dialog corresponding to the one or more tones of voice.

12. The method of claim 1, wherein:
the computer system receives the user speech data from a user device;
the user device comprises a speaker;
the method further comprises segmenting the audio response into a plurality of sequential audio responses; and
causing the audio response to be played to the user comprises sequentially transmitting each sequential audio response to the user device, wherein the user device sequentially plays the plurality of sequential audio responses to the user via the speaker.

13. The method of claim 12, wherein segmenting the audio response into a plurality of sequential audio responses comprises:
identifying one or more pauses in the audio response; and
segmenting the audio response based on the one or more pauses, thereby generating the plurality of sequential audio responses.

14. The method of claim 12, wherein segmenting the audio response into a plurality of sequential audio responses comprises:
identifying one or more pauses in the textual response based on one or more textual characters indicative of pauses in speech; and
segmenting the audio response based on the one or more pauses, thereby generating the plurality of sequential audio responses.

15. The method of claim 12, further comprising:
receiving additional user speech data; and
transmitting a termination signal to the user device in response to receiving additional user speech data, wherein the user device terminates sequentially playing the plurality of sequential audio responses to the user in response to the termination signal.

16. The method of claim 12, further comprising:
receiving additional user speech data; and
terminating sequentially transmitting the plurality of sequential audio responses to the user device in response to receiving the additional user speech data, thereby causing the user device to terminate sequentially playing the plurality of sequential audio responses to the user.

17. The method of claim 1, wherein the user speech data comprises a first segment of user speech data, wherein the textual response comprises a first textual response, wherein the one or more tonal indicators comprise one or more first tonal indicators, wherein the one or more text-to-speech models comprise one or more first text-to-speech model, wherein the audio response comprises a first audio response, and wherein the method further comprises:
receiving a second segment of user speech data corresponding to the user;
generating, using the response model, a second textual response to the second segment of user speech data and one or more second tonal indicators based on the second segment of user speech data;
determining, based on the one or more second tonal indicators, one or more second text-to-speech models corresponding to the one or more second tonal indicators;
generating, using the one or more second text-to-speech models, a second audio response to the user speech data; and
causing the second audio response to be played to the user.

18. The method of claim 17, wherein the computer system performs at least one of the steps of generating the second textual response, determining the one or more second text-to-speech models, or generating the second audio response prior to causing the first audio response to be played to the user.

19. A method performed by a user device for generating an audio response and playing the audio response to a user, the method comprising:
recording the user, thereby generating a user audio recording;
generating, based on the user audio recording, user speech data;
generating, using a response model, a textual response and one or more tonal indicators corresponding to the user speech data;
determining, based on the one or more tonal indicators, one or more text-to-speech models corresponding to the one or more tonal indicators;
generating, using the one or more text-to-speech models, the audio response to the user speech data; and
playing the audio response to the user.

20. A computer system comprising:
a processor; and
a non-transitory computer readable medium coupled to the processor, the non-transitory computer readable medium comprising code, executable by the processor for implementing the method of claim 1.
